(19) United States
(12) Patent Application Publication
(10) Pub. No.: US 2025/0385752 A1
(43) Pub. Date: Dec. 18, 2025

(54) METHODS, ARCHITECTURES, APPARATUSES AND SYSTEMS FOR NETWORK CODING CONTROL

(71) Applicant: InterDigital Patent Holdings, Inc., Wilmington, DE (US)

(72) Inventors: Chia-Hung Wei, Chesterbrook, PA (US); Martino Freda, Laval (CA); Pascal Adjakple, Great Neck, NY (US); Benoit Pelletier, Roxboro (CA); Ghyslain Pelletier, Montréal (CA)

(21) Appl. No.: 18/743,933

(22) Filed: Jun. 14, 2024

(51) Int. Cl. H04L 1/00; H04W 28/04

(52) U.S. Cl. CPC H04L 1/0025; H04L 1/0009; H04W 28/04

(57) ABSTRACT

A method, implemented in a WTRU is described herein. The method may include receiving configuration information from a network, indicating a first NC configuration and a second NC configuration, the first NC configuration indicating (i) a first condition associated with a first amount of missing service data units (SDUs) and (ii) a missing SDU event condition. The method may include sending to the network a first set of network coded packets according to the first NC configuration and receiving from the network a first plurality of status reports associated with the first set of network coded packets. The method may include determining that a first number of status reports of the first plurality of status reports for which the first condition is satisfied, may satisfy the missing SDU event condition.

### TECHNICAL FIELD

The present disclosure is generally directed to the fields of communications, software and encoding, including methods, architectures, apparatuses, and systems directed to network coding control.

### BACKGROUND

Network coding is a packet processing function that transforms X input packet(s) into Y output packet(s). A receiver receiving at least X out of Y transmitted coded packets may be able to recover the transmitted information. Embodiments described herein have been designed with the foregoing in mind.

### SUMMARY

Methods, architectures, apparatuses, and systems directed to network coding control are described herein. In an embodiment, a wireless transmit/receive unit (WTRU) is described. The WTRU may include circuitry including any of a transmitter, a receiver, a processor, and a memory. The circuitry may be configured to receive configuration information from a network. In various embodiments, the configuration information may indicate a first network coding (NC) configuration and a second NC configuration. In various embodiments, the first NC configuration may indicate (i) a first condition associated with a first amount of missing service data units (SDUs) and (ii) a missing SDU event condition. In various embodiments, any of the first NC configuration and the second NC configuration may indicate a switching prohibit duration. The circuitry may be configured to send to the network a first set of network coded packets according to the first NC configuration. The circuitry may be configured to receive from the network a first plurality of status reports associated with the first set of network coded packets. The circuitry may be configured to determine that a first number of status reports of the first plurality of status reports for which the first condition is satisfied, may satisfy the missing SDU event condition. The circuitry may be configured to send to the network a second set of network coded packets according to the second NC configuration based on the first number of status reports satisfying the missing SDU event condition. In various embodiments, the second NC configuration may be applied for at least the switching prohibit duration.

In an embodiment, a method implemented in a WTRU is described. The method may include receiving configuration information from a network. In various embodiments, the configuration information may indicate a first NC configuration and a second NC configuration. In various embodiments, the first NC configuration may indicate (i) a first condition associated with a first amount of missing service data units (SDUs) and (ii) a missing SDU event condition.

In various embodiments, any of the first NC configuration and the second NC configuration may indicate a switching prohibit duration. The method may further include sending to the network a first set of network coded packets according to the first NC configuration. The method may further include receiving from the network a first plurality of status reports associated with the first set of network coded packets. The method may further include determining that a first number of status reports of the first plurality of status reports for which the first condition is satisfied, may satisfy the missing SDU event condition. The method may further include sending to the network a second set of network coded packets according to the second NC configuration based on the first number of status reports satisfying the missing SDU event condition. In various embodiments, the second NC configuration may be applied for at least the switching prohibit duration.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of network coding (NC) in a protocol stack;

FIG. 3 is a diagram illustrating an example of network coding protocol implementation in a packet data convergence protocol (PDCP) entity;

FIG. 4 is a diagram illustrating an example segmented service data unit (SDU) based NC;

FIG. 5 is a diagram illustrating an example cross-SDUs based NC;

FIG. 6 is a diagram illustrating an example procedure of a NC configuration switching;

FIG. 7 is a diagram illustrating an example network coding activation/deactivation medium access control (MAC) control element (CE) for a MAC entity;

FIG. 8 is a diagram illustrating an example network coding radio link control (RLC) activation/deactivation MAC CE;

FIG. 9 is a diagram illustrating an example network coding method activation/deactivation MAC CE;

FIG. 10 is a diagram illustrating an example NC protocol with one coding method activated;

FIG. 11 is a diagram illustrating an example NC protocol with at least one secondary coding method activated;

FIG. 12 is a diagram illustrating an example NC protocol with at least one secondary RLC entity activated;

FIG. 13 is a diagram illustrating an example NC protocol; and

FIG. 14 is a diagram illustrating an example method for controlling network coding.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

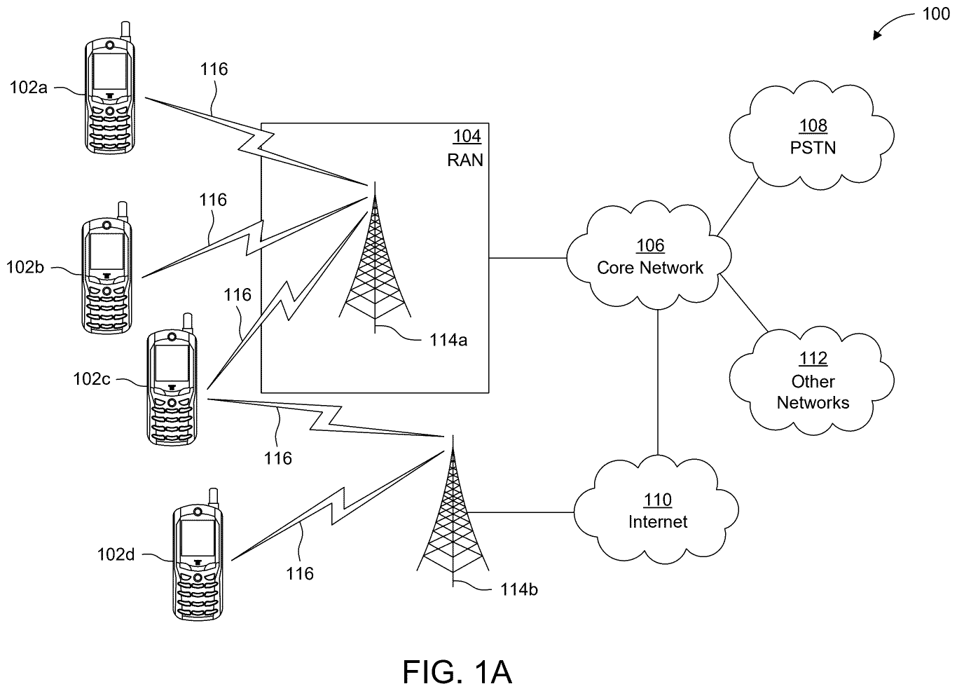

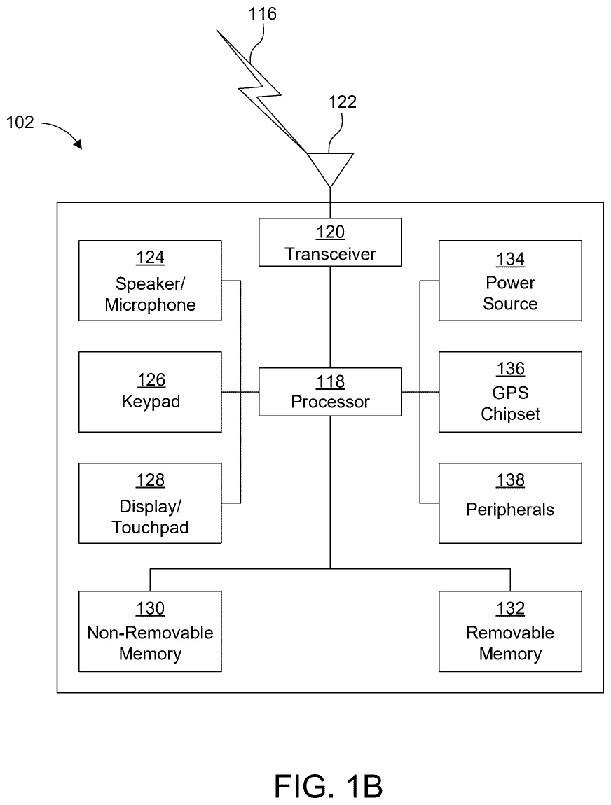

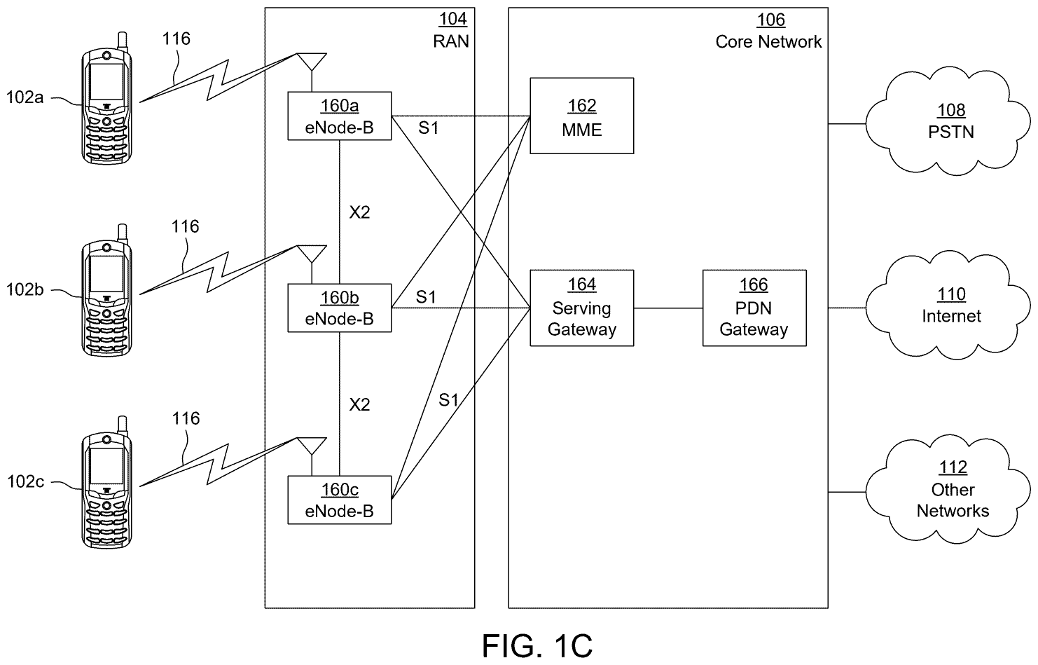

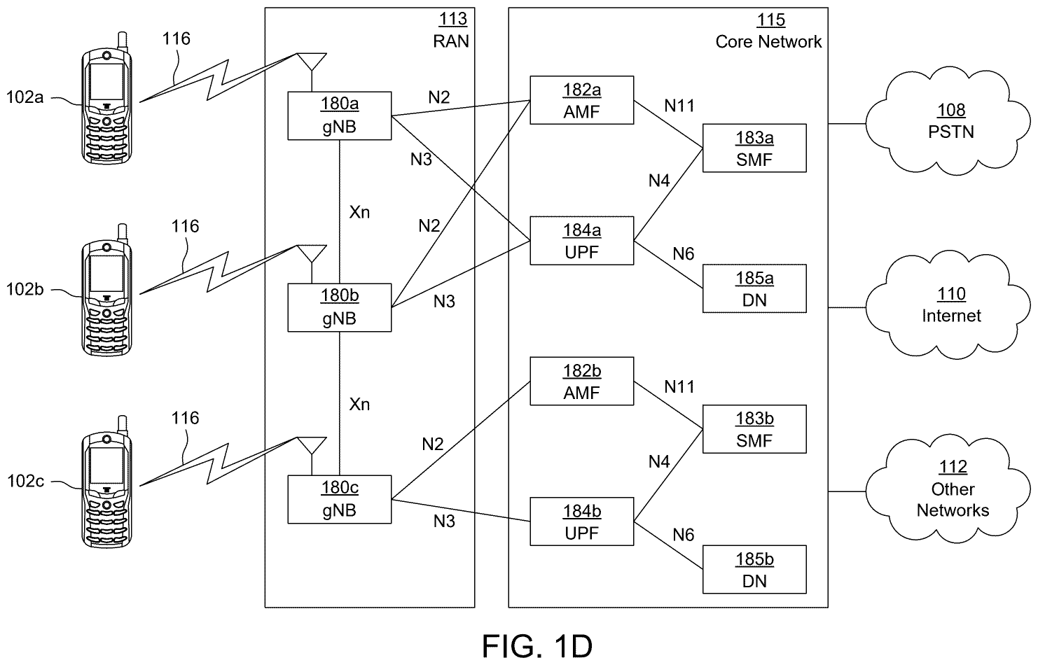

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANS (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”.

In embodiments described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’

### Network Coding

Network coding is a packet processing function that transforms X (e.g., a first number of) input packet(s) into Y (e.g., a second number of) output packet(s), which may be referred to herein as network coded packet(s). In an example, X may be greater than or equal to two and Y may be greater than or equal to X, with the case where X equal to one and Y equal to one being a specific case. The X input packets being coded together may form a network coding generation (referred to herein as a generation). An input packet may be any of service data unit (SDU) and a segment of an SDU. An output packet may be referred to herein as PDU. Network coding may be seen as a packet processing function transforming X SDU(s) into Y PDU(s). In an example, one of (e.g., any of) the Y PDUs may be obtained based on (e.g., a coding process performing) a linear combination of (e.g., any of) the X input packets. The PDUs associated with the same generation may be of same or different characteristics and may be associated with same or different importance/priority levels. Such characteristics may include any of systematic packets, coded packets, less-innovative coded packets, more-innovative coded packets, etc. There may be dependencies between PDUs of the same generation such that, for example, a) the receiver may (e.g., need to) receive Z PDUs or more to recover the X SDUs wherein Z may be less than X; b) how many more PDUs or specific PDUs may be expected (e.g., needed) by the receiver to recover the X SDUs may depend on the PDUs already available at the receiver; c) the scheduling of the PDUs of the same generation may depend on (e.g., be constrained by) the same overall delay budget.

Example of benefits of network coding may include improving reliability under tight latency requirements. Network coding may be applied with or without duplication, or with packet repetition. The use of network coding may alleviate a scheduler from having to select conservative (e.g., low efficiency) modulation and coding scheme (MCS) transmission parameters and/or improve the allocation of other transmission resources to improve overall system performance.

Network coding may operate according to one or more network coding methods as described herein in the following examples.

In an example, a network coding (NC) method may include a segmented-SDU based NC. A segmented-SDU based NC is a network coding scheme where an NC SDU may be segmented into NC SDU segments, and packet generations may comprise (e.g., only) NC SDU segments. Re-assembly of NC SDU segments may be performed at the end destination (decoder) to form the original NC SDU.

In an example, a NC method may include a network coding scheme where packet generations may comprise (e.g., only) non-segmented SDUs. Such NC method may be referred to as cross-SDUs based NC SDU (concatenation-based NC).

In an example, a NC method may include a network coding scheme where a generation may comprise NC SDU segments which may be segmented from more than one SDU. Such NC method may be referred to as hybrid-based NC.

For the sake of clarity, embodiments are described herein with the example of network coding for increasing the robustness of transmissions. Embodiments are not limited to network coding and any kind of source/channel/error coding capable to add redundancy to transmitted information to be used at the receiving side to recover the information may be applicable to embodiments described herein.

### Examples of Use Cases and Deployments for Network Coding

Network coding (NC) may be applied to improve reliability and/or reduce latency of wireless transmissions in a number of connectivity scenarios and data services. For example, NC may improve data transmissions for real-time immersive and multi-sensory communication and services, such as cross reality (XR) or metaverse. NC may enable providing communication services for connected industries and automation that may have latency requirements as low as, for example, in the sub-ten millisecond or even sub millisecond ranges.

The 5G NR design supports packet data convergence protocol (PDCP) duplications and other plain duplication redundancy techniques in support of ultra-reliable and low latency communication services. Based on increasing requirements in terms of various key performance metrics such as any of spectral efficiency, latency, reliability, data rate and the expectation of concurrent support of these requirements, the use of redundancy via plain duplication may not be efficient nor scalable.

Network coding may provide flexible redundancy coding rate for different reliability requirements and flexible split of transmission of coded packets over different transmission paths (such as e.g., any of frequency diversity, spatial diversity, code diversity, etc.) and/or over different time instances (for time domain diversity).

In a 5G system, network coding may be used to improve efficiency for the support of any of multicast broadcast services, sidelink services (e.g., vehicle to everything (V2X) services), enhanced mobile broadband services with the added benefits of improved link efficiency, reduced latency, improved reliability and reduced buffering requirements. Example of deployment scenarios may include any of carrier aggregation (CA), dual connectivity (DC), integrated access and backhaul (IAB), sidelink including sidelink relay.

In embodiments described herein, the system may be referred to the protocol stack defined by third generation partnership project (3GPP) for radio access network (RAN) of new radio (NR) mobile communication system.

In embodiments described herein, the network coding is described as implemented as a protocol in the packet data convergence protocol (PDCP). Embodiments are not limited to NC encoder/decoder included in a PDCP layer. Inclusion of a NC encoder/decoder in any protocol layer able to transmit and receive any kind of packet/data may be applicable to embodiments described herein.

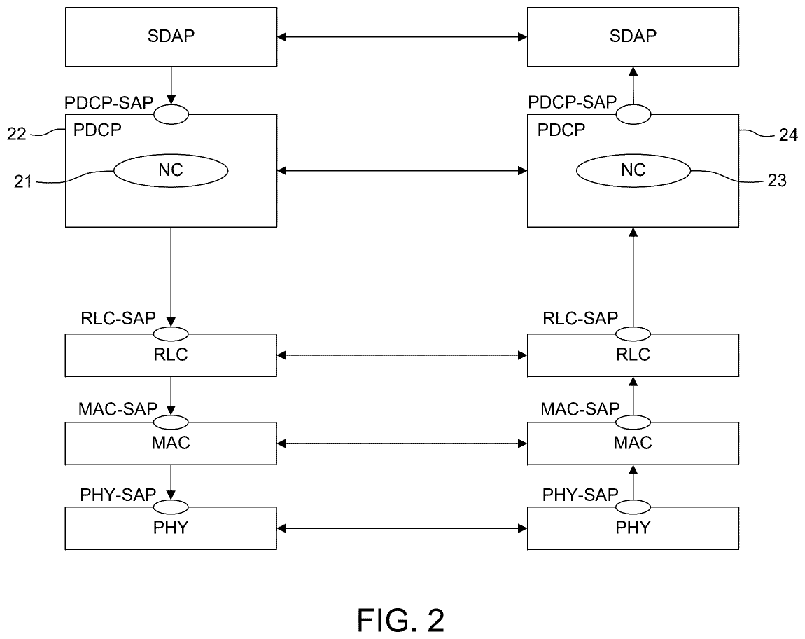

FIG. 2 is a diagram illustrating an example of network coding in a protocol stack. The NC encoder 21 may be operating at the PDCP layer transmitter 22 and the NC decoder 23 may be operating at the PDCP layer receiver 24.

In embodiments described herein, in order to limit impact on legacy functionalities, the NC protocol is treated as a black box from the PDCP perspective.

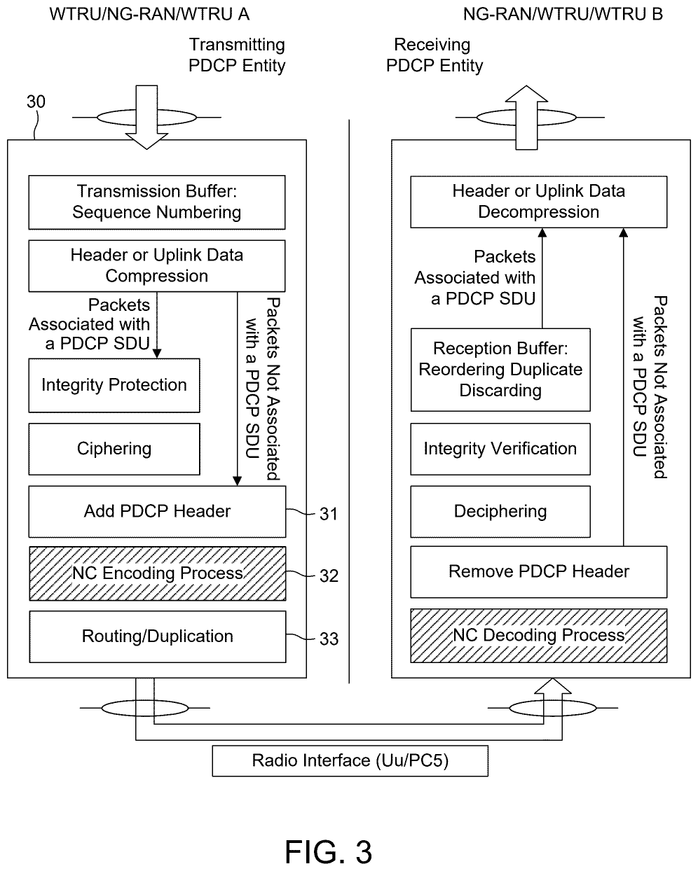

FIG. 3 is a diagram illustrating an example of network coding protocol implementation in a PDCP entity. For example, the NC protocol (e.g., encoding process 32) may be performed after PDCP header addition 31 and before routing PDCP PDU(s) 33 to lower layer. In an example, for a (e.g., each) PDCP SDU, the PDCP entity 30 may generate a PDCP header to be attached to the (e.g., each) PDCP SDU before performing NC encoding process 32. After the NC encoding process 32, the PDCP entity 30 may route the output packet (e.g., PDCP PDU) to the lower layer. In the example described herein, the PDCP header may be encoded by the NC protocol.

For the sake of simplicity, embodiments are described herein with the example of the NC encoding process being performed between PDCP header addition and routing the lower layers. Embodiments described herein are not limited to the implementation example illustrated at FIG. 3. For example, implementations where the PDCP header may not be encoded by the NC protocol and/or the NC protocol may be placed in different orders within PDCP entity are compatible with embodiments described herein.

In embodiments described herein, the term systematic PDU may refer to a PDU carrying systematic packet, and the term non-systematic PDU may refer to a PDU carrying non-systematic packet.

In embodiments described herein, a timer may be running once (e.g., after) it may be started, until it may be stopped or until it may expire; otherwise, it may not be running. A timer can be started if it is not running or restarted if it is running. A timer may (e.g., always) be started or restarted from its initial value. The duration of a timer may not be updated until it may be stopped or may expire.

Embodiments described herein focus on how to evaluate the successful transmission in PDCP layer after introducing the network coding, and what are the potential impacts to the legacy retransmission behavior.

Network coding protocol is not supported in 3GPP radio protocols.

Embodiments described allow to control NC configuration switching for network coding. With multiple independent network coding configurations, network coding may increase reliability and may reduce latency. In an example, a WTRU may be configured with multiple NC coding configurations. Embodiments described herein provide mechanisms for switching the network coding configurations dynamically. Embodiments described herein describe measurement, signaling and WTRU behavior that may be introduced to support the network coding configurations switching.

Embodiments described herein allow to avoid frequent configuration switching. In an example, a WTRU may change its NC configuration. The WTRU may perform a number of operations including e.g. any of NC context release procedure, NC process release procedure and/or discard any received/stored PDU(s). This may result in delays/overheads and e.g., waste of radio resources due to data re-transmission. Embodiments described herein allow to reduce (e.g., unnecessary) reconfiguration.

Embodiments described herein allow to control activation and deactivation of network coding. The power consumption and the radio resource occupancy may be increased based on NC encoding/decoding related processes and corresponding PDUs transmission. It will be beneficial to let the NC protocol be activated dynamically (e.g., only when needed). Embodiments described herein describe mechanisms to control the activation and deactivation of the network coding. Pre-configuration and signaling to be introduced for dynamic NC activation/deactivation is described herein.

### Overview

In an example, a WTRU may be configured with multiple NC configurations via downlink radio resource control (RRC) message. One (e.g., each) of the multiple NC configuration may be associated with a condition.

In an example, a WTRU may be configured with multiple NC configurations, and the WTRU may determine to switch to a NC configuration based on evaluating whether a corresponding condition may be met.

In an example, a WTRU may be configured with multiple NC configurations, and the WTRU may determine to switch to a NC configuration based on any of a received NC configuration switching indicator, one or more of received PDCP status report and a reference signal measurement.

In an example, after the WTRU may switch NC configuration, the WTRU may transmit (e.g., information indicating) a NC configuration switching confirmation to the gNB.

In an example, after the WTRU may switch NC configuration, the WTRU may be prohibited to switch NC configuration within a period of time.

In an example, activation/deactivation state of a NC protocol may be changed dynamically by (e.g., based on) a downlink signal.

### Overview of Control of Network Coding Configuration

In an example, a WTRU operating a NC process by applying a first NC configuration (e.g., with aggressive coding). The WTRU may switch to a second NC configuration (e.g., providing more robust coding protection) after consecutive missing SDU detection. The WTRU may determine to switch back to the first NC configuration for the NC process operation after a timer duration may have elapsed after applying the second NC configuration.

A method for a WTRU, configured with NC protocol, is described herein. The WTRU may determine to apply different NC configurations for a NC process, the method comprising one or more of the following steps.

In an example, the WTRU may receive from a network (e.g., configuration information e.g., via one or more RRC messages indicating) a first and a second NC configurations for NC. The first NC configuration may include (e.g., indicate) one or more of: (i) a first missing SDU percentage threshold, (ii) a missing SDU accumulation threshold, (iii) a missing SDU detection duration value, and (iv) a first set of NC process parameters. The second NC configuration may include (e.g., indicate) one or more of: (i) a second missing SDU percentage threshold, (ii) a NC configuration switching prohibit duration value and (iii) a second set of NC process parameters.

In an example, the WTRU may apply the first NC configuration for a NC process (e.g., by sending to the network a first set of network coded packets according to the first NC configuration) and may receive one or more first PDCP status reports from the network (e.g., associated with at least the first set of network coded packets).

In an example, the WTRU may apply the second NC configuration for the NC process if consecutive missing SDUs are detected based on the one or more first PDCP status reports. In an example, the consecutive missing SDUs may be detected based on e.g., (i) accumulating a number of PDCP status reports indicating a number of missing SDUs satisfying a first condition (e.g., being equal to or greater than the first missing SDU percentage threshold), and (ii) the accumulated value being equal to or greater than the missing SDU accumulation threshold, for example, in any time span, wherein the time span may be determined, for example, based on the missing SDU detection duration value.

In an example, the WTRU may indicate the network (e.g., send information indicating) the NC configuration being applied after changing (e.g., determining to change) to the second NC configuration for the NC process.

In an example, the WTRU may apply the first NC configuration for the NC process after determining that (i) a number of missing SDUs indicated in PDCP status report may fail to satisfy a second condition (e.g., be smaller than the second missing SDU percentage threshold) and (ii) the NC configuration switching prohibit duration (indicated by the NC configuration switching prohibit duration value) may have elapsed since switched to the second NC configuration.

In an example, after determining the NC configuration switching prohibit duration may have elapsed since switched to the second NC configuration, the WTRU may detect whether a (e.g., specific) PDCP status report may be received for a time duration which may have been indicated by the second NC configuration. The (e.g., specific) PDCP status report may indicate a number of missing SDUs equal to or greater than the second missing SDU percentage threshold. The WTRU may remain in the second NC configuration for the NC process if the (e.g., specific) PDCP status report (e.g., indicating a number of missing SDUs equal to or greater than the second missing SDU percentage threshold) is received. The WTRU may switch to the first NC configuration for the NC process if no (e.g., specific) PDCP status report (indicating a number of missing SDUs equal to or greater than the second missing SDU percentage threshold) is received (e.g., over the time duration).

### Network Coding Aspects

A transmitting WTRU may be configured with a NC protocol in the PDCP layer. The NC protocol may perform NC encoding process including transforming X input packet(s) into Y output packet(s). In embodiments described herein, the X input packet(s) may be referred to as a NC generation. The NC protocol may support multiple NC generations to be NC encoded individually in parallel. For example, a (e.g., each) NC generation may be NC encoded independently based on individual input packets (e.g., SDUs).

The NC encoding process may be performed according at least two different approaches: segmented-SDU based and cross-SDUs based. The two approaches are described herein by several stages.

### Segmented-SDU Based NC:

An operation of the segmented-SDU based NC configured to a transmitting WTRU may be described as a set of steps included in the following stages.

A first stage may include, at the transmitting WTRU, the steps of (i) receiving one or more SDU(s) from the upper layer, and (ii) performing none, one or more pre-process(es) for the one or more SDU(s), wherein the pre-process may include (e.g., without limitation) any of the legacy procedures in the PDCP layer as illustrated in FIG. 3, such as e.g., any of sequence numbering, header compression, uplink data compression and/or integrity protection, ciphering, etc.

A second stage may include, at the NC coding protocol or the transmitting WTRU, the steps of segmenting by (e.g., each of) the one or more SDU(s) into multiple SDU segments. In embodiments described herein, an SDU segment may refer to a segmented SDU and/or segment of SDU.

A third stage may include, at the NC coding protocol, the steps of proceeding the NC encoding by using the SDU segments and applying coding coefficient associated with (e.g., each of) the SDU segments. A coding coefficient may include (e.g., without limitation) a value which may be derived based on a pre-configured coefficient. In an example, the coding coefficients may be selected based on the order of (e.g., each of) the SDU segments within the original SDU.

A fourth stage may include the steps of (i) generating by the NC coding protocol one or more PDU(s), (ii) performing, by the transmitting WTRU, none, one or more post-process(es) for the one or more PDU(s), wherein the post-process may include (e.g., without limitation) any of the legacy procedures in the PDCP layer, and (iii) delivering by the transmitting WTRU the one or more PDU(s) to the lower layer.

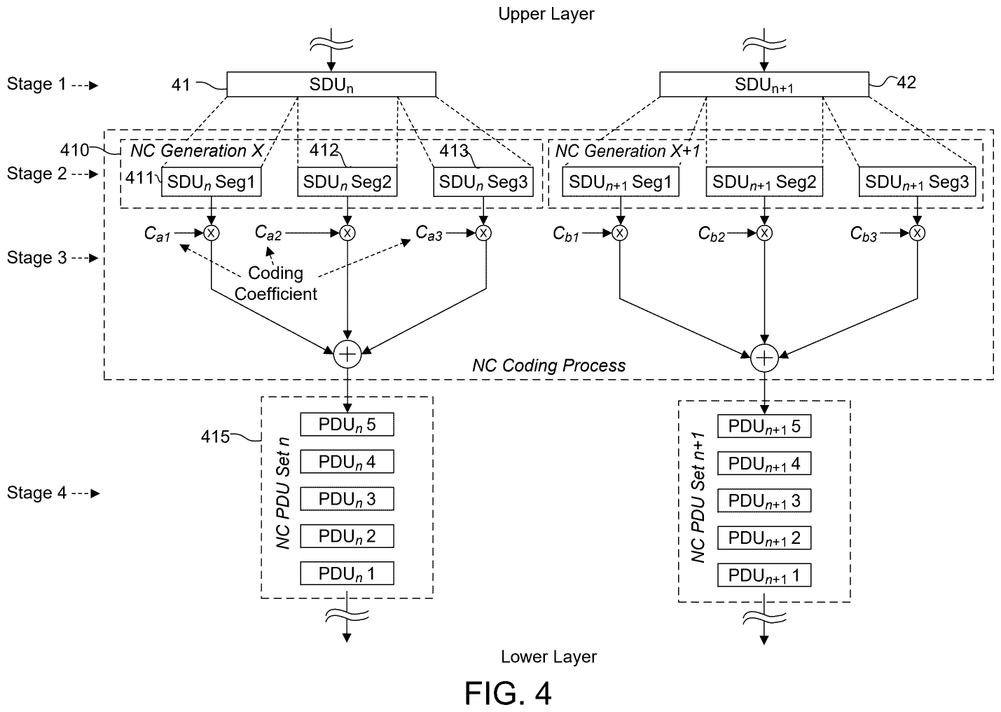

FIG. 4 is a diagram illustrating an example segmented-SDU based NC.

The notation “SDUₙ” shown in FIG. 4 may refer to the input packet n of the NC encoding process.

The notation “SDUₙ Seg X” shown in FIG. 4 may refer to the X-th segment of SDUn.

The notation “PDUₙ X” shown in FIG. 4 may refer to the X-th output packet of the NC encoding process by using SDUn.

The notation “Cₐ₁” shown in FIG. 4 may refer to the first coding coefficient of coefficient vector a, wherein a coefficient vector may have one or more coding coefficients.

The notation “NC PDU set n” shown in FIG. 4 may refer to a set of coded packets encoded by using SDUₙ.

As shown at FIG. 4, the transmitting WTRU may receive SDUₙ 41 and SDUₙ₊₁ 42 from the upper layer e.g., sequentially. The SDUₙ 41 and SDUₙ₊₁ 42 may be processed via individual NC processes, respectively. For example, the SDUₙ 41 may be segmented into a number N segments and the number N may be equal to 3 in this example (e.g., SDUₙ Seg 1 411, SDUₙ Seg 2 412, and SDUₙ Seg 3 413). The SDUₙ Seg 1 411, SDUₙ Seg 2 412, and SDUₙ Seg 3 413 may be referred to as NC generation X 410. The NC generation X 410 may be encoded by applying the number N coding coefficients for (e.g., each) generated coded packets (e.g., one coding coefficient per SDU-segment for a (e.g., each) coded packet) and may generate multiple coded packets (e.g., PDUₙ 1, PDUₙ 2, PDUₙ 3, PDUₙ 4 and PDUₙ 5). The coded packets associated with a same NC generation may be referred to as belonging to same NC PDU set 415. For example, the PDUₙ 1, PDUₙ 2, PDUₙ 3, PDUₙ 4 and PDUₙ 5 may be belonging to NC PDU set n 415. In an example, it can be interpreted as the NC PDU set n may contain the PDUₙ 1, PDUₙ 2, PDUₙ 3, PDUₙ 4 and PDUₙ 5. In this example with generation size N=3, the coding coefficient Cₐ₁, Cₐ₂ and Cₐ₃ may be represented as three coding coefficient vectors applied to encode SDUₙ Seg 1 411, SDUₙ Seg 2 412, and SDUₙ Seg 3 413.

A (e.g., each) coding vector may contain multiple coding coefficients, and (e.g., each of) the PDUₙ 1, PDUₙ 2, PDUₙ 3, PDUₙ 4 and PDUₙ 5 may be generated by applying coding coefficients of different coefficient vectors. Similarly, the SDUₙ₊₁ may be segmented into multiple segments (e.g., SDUₙ₊₁ Seg 1, SDUₙ₊₁ Seg 2, and SDUₙ₊₁ Seg 3). The SDUₙ₊₁ Seg 1, SDUₙ₊₁ Seg 2, and SDUₙ₊₁ Seg may be referred to as NC generation Y. The NC generation Y may be encoded by applying coding coefficients and may generate multiple coded packets (e.g., PDUₙ₊₁ 1, PDUₙ₊₁ 2, PDUₙ₊₁ 3, PDUₙ₊₁ 4 and PDUₙ₊₁ 5). The PDUₙ₊₁ 1, PDUₙ₊₁ 2, PDUₙ₊₁ 3, PDUₙ₊₁ 4 and PDUₙ₊₁ 5 may be belonging to NC PDU set n+1. In an example, it can be interpreted as the NC PDU set n+1 may contain the PDUₙ₊₁ 1, PDUₙ₊₁ 2, PDUₙ₊₁ 3, PDUₙ₊₁ 4 and PDUₙ₊₁ 5. The coding coefficient C_{b1}, C_{b2} and C_{b3} may be represented as three coding coefficients applied to encode SDUₙ₊₁ Seg 1, SDUₙ₊₁ Seg 2, and SDUₙ₊₁ Seg 3. A (e.g., each) coefficient vector may contain multiple coding coefficients, and (e.g., each of) the PDUₙ₊₁ 1, PDUₙ₊₁ 2, PDUₙ₊₁ 3, PDUₙ₊₁ 4 and PDUₙ₊₁ 5 may be generated by applying coding coefficients within different coding vectors.

### Cross-SDUs Based NC

An operation of the cross-SDUs based NC configured to a transmitting WTRU may be described as a set of steps included in the following stages.

A first stage may include, at the transmitting WTRU, the steps of (i) receiving one or more SDU(s) from the upper layer, (ii) performing none, one or more pre-process(es) for the one or more SDU(s), wherein the pre-process may include (e.g., without limitation) any of the legacy procedures in the PDCP layer and (iii) grouping multiple SDUs as a NC SDU set (NC generation) for the NC encoding process.

A second stage may include, at the NC coding protocol, the steps of proceeding the NC encoding by using the NC SDUs of the NC SDU set and by applying the coding coefficients associated with (e.g., each of) the SDUs of the NC SDU set. The coding coefficient may include (e.g., without limitation) a value which may be derived based on a pre-configured coefficient. The coding coefficients may be selected based on the order of (e.g., each) SDUs within the NC SDU set.

A third stage may include the steps of (i) generating one or more PDU(s) by the NC coding protocol, (ii) performing by the transmitting WTRU perform none, one or more post-process(es) for the one or more PDU(s), wherein the post-process may include (e.g., without limitation) any of the legacy procedures in the PDCP layer, and (iii) delivering by the transmitting WTRU the one or more PDU(s) to the lower layer.

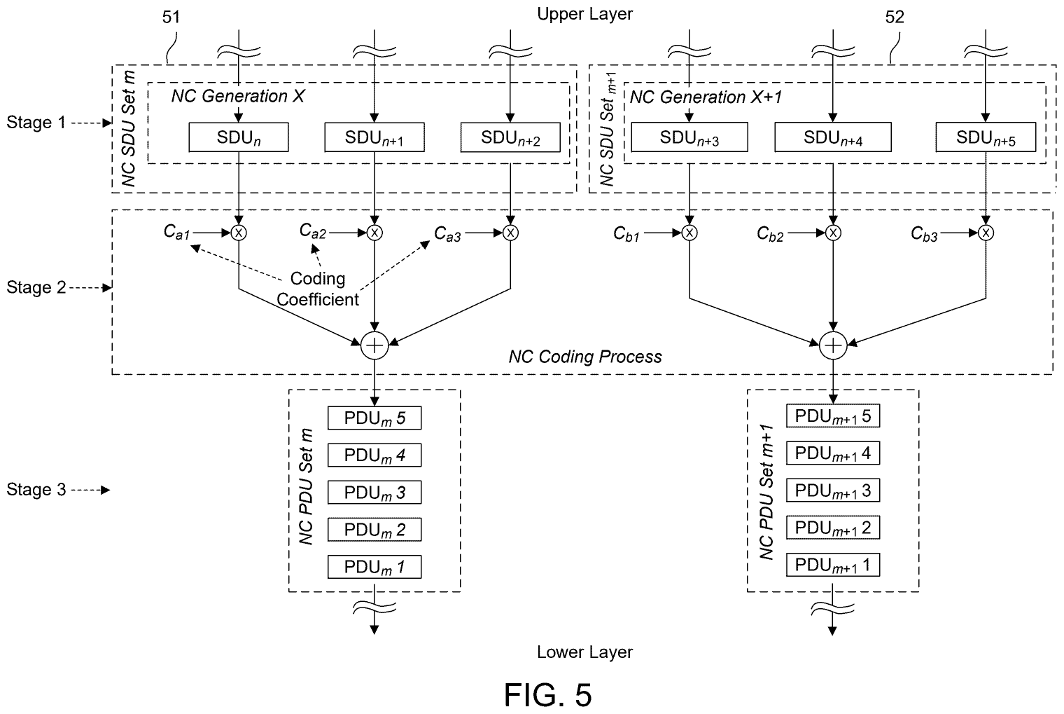

FIG. 5 is a diagram illustrating an example cross-SDUs based NC.

The notation “SDU.”, shown in FIG. 5 may refer to the input packet n of NC encoding process.

The notation “NC SDU Set m” shown in FIG. 5 may refer to the input packet Set m of a NC encoding process. The SDU Set m may be referred to as a NC generation.

The notation “PDUₘ X” shown in FIG. 5 may refer to the X-th output packet of the NC encoding process by using NC SDU set m.

The notation “Cₐ₁” shown in FIG. 5 may refer to the first coding coefficient of coefficient vector a, wherein a coefficient vector may have one or more coding coefficient(s).

The notation “NC PDU set m” shown in FIG. 5 may refer to a set of coded packets encoding by using NC SDU Set m.

As shown at FIG. 5, the transmitting WTRU may group a number N of SDUs as a NC SDU set, where the number N is equal to three in illustrated example. For example, the transmitting WTRU may receive SDUₙ, SDUₙ₊₁, SDUₙ₊₂, SDUₙ₊₃, SDUₙ₊₄, and SDUₙ₊₅ from the upper layer e.g., sequentially. The SDUₙ, SDUₙ₊₁ and SDUₙ₊₂ may be grouped as a NC SDU set m 51. The SDUₙ₊₃, SDUₙ₊₄, and SDUₙ₊₅ may be grouped as NC SDU set m+1 52. The NC SDU set m 51 and the NC SDU set m+1 52 may be referred to as NC generation X and NC generation Y respectively. The SDUₙ, SDUₙ₊₁ and SDUₙ₊₂ may be encoded by applying N coding coefficients for (e.g., each of) the generated coded packets (e.g., one coding coefficient per SDU for a (e.g., each) coded packet) and multiple coded packets may be generated (e.g., PDUₘ 1, PDUₘ 2, PDUₘ 3, PDUₘ 4 and PDUₘ 5). The coded packets associated with a same NC generation may be referred to as belonging to same NC PDU set. For example, PDUₘ 1, PDUₘ 2, PDUₘ 3, PDUₘ 4 and PDUₘ 5 may belong to NC PDU set m. For example, it may be interpreted as the NC PDU set m may contain the PDUₘ 1, PDUₘ 2, PDUₘ 3, PDUₘ 4 and PDUₘ 5. According to the illustrated example with generation size N=3, the coding coefficient Cₐ₁, Cₐ₂ and Cₐ₃ may be represented as three coding coefficient vectors applied to encode SDUₙ, SDUₙ₊₁ and SDUₙ₊₂. A (e.g., each) coding vector may contain multiple coding coefficients, and (e.g., each of) the PDUₘ 1, PDUₘ 2, PDUₘ 3, PDUₘ 4 and PDUₘ 5 may be generated by applying coding coefficients of different coding coefficient vectors. Similarly, the SDUₙ₊₃, SDUₙ₊₄, and SDUₙ₊₅ may be encoding by applying coding coefficients and multiple coded packets may be generated (e.g., PDUₘ₊₁ 1, PDUₘ₊₁ 2, PDUₘ₊₁ 3, PDUₘ₊₁ 4 and PDUₘ₊₁ 5). The PDUₘ₊₁ 1, PDUₘ₊₁ 2, PDUₘ₊₁ 3, PDUₘ₊₁ 4 and PDUₘ₊₁+5 may belong to NC PDU set m+1. For example, it may be interpreted as the NC PDU set m+1 may contain the PDUₘ₊₁ 1, PDUₘ₊₁ 2, PDUₘ₊₁ 3, PDUₘ₊₁ 4 and PDUₘ₊₁ 5. The coding coefficient C_{b1}, C_{b2} and C_{b3} may be represented as three coding coefficients applied to encode SDUₙ₊₃, SDUₙ₊₄, and SDUₙ₊₅. A (e.g., each) coding vector may contain multiple coding coefficients, and (e.g., each of) the PDUₘ₊₁ 1, PDUₘ₊₁ 2, PDUₘ₊₁ 3, PDUₘ₊₁ 4 and PDUₘ₊₁ 5 may be generated by applying coding coefficients of different coding coefficient vectors.

In embodiments described herein, the SDU and PDU may be referred to as the input packet of the NC protocol and the output packet of the NC protocol, respectively. For example, the SDU may be pre-processed by any legacy procedure(s) in the PDCP layer before being input to the NC protocol. For example, the PDU may be post-processed by any legacy procedure(s) in the PDCP layer after being output from the NC protocol.

### Terminology

In embodiments described herein, a coefficient matrix may refer to a matrix carrying a set of coding coefficients. A (e.g., each) coefficient matrix may contain one or multiple rows and one or multiple columns.

In embodiments described herein, a coefficient vector may refer to a set of coding coefficients which may be refer to a row of a coefficient matrix or a column of a coefficient matrix. A (e.g., each) coefficient matrix may contain one or multiple rows and one or multiple columns. A (e.g., each) row may be represented as a coefficient vector. A (e.g., each) coefficient vector may contain one or multiple of coding coefficients. each A (e.g., each) coefficient matrix may be associated with a coefficient matrix index and a (e.g., each) coefficient vector may be associated with a coefficient vector index.

In embodiments described herein, a coding coefficient may refer to a scalar value from a finite field e.g., a field containing a finite number of elements. A field is a set on which addition, subtraction, multiplication, and division are defined and behave as the corresponding operations on rational and real numbers do. As with any field, a finite field is a set on which the operations of multiplication, addition, subtraction and division are defined and satisfy basic rules of arithmetic, with the result of such operation being an element of the finite field. In the case the field is a binary extension field, the coefficients may be elements of a field of size 25 (e.g., number of elements in the field) where s may be the size (e.g., length in bit) of the coefficient. Examples of binary extension fields may include GF(2) binary field where each element is one bit long, GF(2²) binary-2 field where each element is two bits long, GF(2⁴) binary-4 field where each element is four bits longs, and GF(2⁸) binary-8 field where each element is one byte long. In enumeration form, GF(2) is the set {0,1}, GF(2²) is the set {00,01,10,11}, GF(2⁴) is the set {0000,0001,0010,0011, 0100,0101,0110, 0111, 1000, 1001, 1010, 1011, 1100, 1101, 1110, 1111}, etc. Based on a packet size being larger than the field size, a (e.g., each) packet may be seen as a set of elements from the Galois field (e.g., referred to as symbols) appended together. Network coding arithmetic operations may be symbols wise operations based on the coding coefficients and the symbols of the packets being coded together, being of the size, and being elements of the same finite field.

The coefficients may be configuration based. In an example, the coefficients may be (e.g., randomly) selected from a finite field or a generator matrix (e.g., look up table) configured into the WTRU. In another example, the coefficients may be selected deterministically based on a finite field or a generator matrix configured into the WTRU according to a (e.g., specified, pre-defined) algorithm.

Embodiments are described herein with the example of applying a first/second coefficient matrix for generating NC PDUs. Embodiments described herein are applicable to any set/plurality of coding coefficients to be applied to SDUs for generating NC PDUs.

NC process initialization is described herein.

A NC process may be initiated by a receiving WTRU for a NC PDU set. The NC process may be initiated for NC decoding. The NC process may execute at least the NC decoding for the NC PDU set and may maintain NC context related to the NC PDU set. A PDU belonging to a NC PDU set may be associated with a NC process initiated for the NC PDU set. For example, different NC PDU sets may be NC decoded by different NC processes. For example, the receiving WTRU may initiate a NC process for a (e.g., each) of NC PDU set, and PDUs belonging to a same NC PDU set may be associated with the same NC process.

A NC process may be released by the receiving WTRU based on one or more condition(s) being satisfied. For example, a NC process may keep performing NC decoding after the NC process may be initiated and before the NC process may be released.

In embodiments described herein, a NC context may include one or more of (i) a context identifier (context ID) or context sequence number, (ii) a coefficient (generator) matrix, (iii) a coefficient (generator) matrix ID, (iv) NC SDU segments or a group of NC SDUs being jointly coded together, (v) a NC generation sequence number, (vi) NC PDUs and (vii) a mapping (e.g., association) between NC SDUs and NC PDUs (e.g., using their respective sequencing information).

In embodiments described herein, the terms “NC process” and “NC context” may be used interchangeably. For example, a receiving WTRU initiating a NC process for a NC PDU set may be equivalent to the receiving WTRU initiating a NC context for the NC PDU set. In another example, a receiving WTRU releasing a NC process of a NC PDU set may be equivalent to the receiving WTRU releasing a NC context for the NC PDU set.

An active NC process is described herein.

In embodiments described herein, a NC process may be an active NC process after the NC process may have been initiated and before it may be released.

A NC process being successfully decoded is described herein.

In embodiments described herein, in case of segmented-SDU based NC being configured, a NC process being successfully decoded may be used interchangeably with any of (i) a SDU having been successfully decoded by the NC process, (ii) a SDU having been recovered by the NC process, (iii) the NC process being associated with a NC PDU set, and a SDU associated with the NC PDU set having been successfully decoded by the NC process, (iv) the NC process being associated with a NC PDU set, and a SDU associated with the NC PDU set having been successfully decoded by the NC process by using the NC PDU set, and (v) the NC decoding process being complete.

In embodiments described herein, in case of cross-SDUs based NC being configured, a NC process being successfully decoded may be used interchangeably with any of (i) all SDUs having been successfully decoded by the NC process, (ii) all SDUs having been recovered by the NC process, (iii) the NC process being initiated for a NC PDU set, and all SDU associated with the NC PDU set having been successfully decoded by the NC process, (iv) the NC process being initiated for a NC PDU set, and all SDU associated with the NC PDU set having been successfully decoded by the NC process by using the NC PDU set, and (v) the NC decoding process being complete.

In embodiments described herein, a PDCP status report may indicate receiving status of a number of SDU(s). For example, the PDCP status report may (e.g., individually) indicate receiving status of the number of SDU(s). The receiving status may include received or missing. A receiving status of a SDU may indicate that the SDU may have been received or may be missing (e.g., may have been lost).

In embodiments described herein, a missing SDU percentage may refer to any of: (alternative 1) the number of missing SDUs within a (e.g., given) PDCP status report (for example, the missing SDU percentage may be equal to the number of SDUs indicated as missing in the PDCP status report) and (alternative 2) the percentage of missing SDUs within a (e.g., given) PDCP status report (for example, the missing SDU percentage may be equal to the number of SDUs indicated as missing in the PDCP status report dived by the number of SDU(s) reported by the PDCP status report).

In embodiments described herein, “missing SDU” and “missing SDU percentage” may be used interchangeably to refer to an amount of missing SDUs. In embodiments described herein, “missing SDU threshold” and “missing SDU percentage threshold” may be used interchangeably to refer to a threshold (e.g., level, value) of missing SDUs.

In embodiments described herein, a missing SDU event may refer to an event where the missing SDU percentage may satisfy a (e.g., threshold) condition (e.g., may be is greater than or equal to a (e.g., missing SDU percentage) threshold, wherein the missing SDU percentage may refer to any of alternative 1 and 2 as described above.

In embodiments described herein, a missing SDU accumulation may refer to any of: (alternative 1) the number of missing SDU events within the missing SDU detection duration, and (alternative 2) the percentage of missing SDU events relative to total number of PDCP status report received within the missing SDU detection duration.

In embodiments described herein, a missing SDU accumulation event may refer to an event where the missing SDU accumulation may satisfy a (e.g., threshold) condition (e.g., may be greater than or equal to the missing SDU accumulation threshold), wherein the missing SDU accumulation may refer to any of alternative 1 and 2 as described above.

A WTRU may be configured with any of a segmented-SDU mode NC protocol and a cross-SDUs mode NC protocol to be operated in the PDCP layer. The NC protocol may be configured by a gNB. For example, the NC protocol may be configured via (e.g., based on receiving) dedicated downlink RRC signaling and/or broadcasted RRC signaling.

### Multiple NC Configurations

In an example, a WTRU may be configured with multiple NC configurations via one or more downlink RRC messages. One (e.g., each) of the NC configurations may carry at least configuration (e.g., information) for NC processing, configuration (e.g., information) for controlling NC configurations switching and/or NC configuration identification.

A transmitting and/or a receiving WTRU may be configured with multiple NC configurations (e.g., the WTRU may receive configuration information indicating one or more NC configurations in one or more (e.g., RRC messages). The multiple NC configurations may be received, for example (and without limitation), from a gNB. The multiple NC configurations may be carried, for example (and without limitation), by one or more downlink RRC messages. A (e.g., each of the multiple) NC configuration(s) may contain one or more of (i) configuration information for NC processing, (ii) configuration information for controlling NC configurations switching and (iii) configuration information for NC configuration identification.

In an example, configuration information for NC processing may include any of a coefficient matrix configuration and a PDU routing configuration.

A coefficient matrix configuration may indicate one or more of coefficient matrix(es) to be applied. A (e.g., each) coefficient matrix may contain one or multiple rows and one or multiple columns. A (e.g., each) row may be represented as a coefficient vector, and a (e.g., each) coefficient vector may contain one or multiple coding coefficients. In an example, a (e.g., each) coefficient matrix may be associated with a coefficient matrix index, and a (e.g., each) coefficient vector may be associated with a coefficient vector index.

A PDU routing configuration may indicate one or more PDU routing methods to be applied by a PDCP entity when (e.g., for) submitting PDU(s) to the lower layers.

In an example, configuration information for controlling NC configurations switching may include a condition configuration indicating parameter(s) to be applied for NC configuration switching determination.

In an example configuration information for NC configuration identification may include a NC configuration index indicating an identity of the NC configuration.

In embodiments described herein, the NC configuration may include any of a radio bearer and a PDCP (e.g., specific) configuration. For example, for different PDCP entities/radio bearers configured with NC protocol respectively, the gNB may provide individual NC configurations for (e.g., each of) the configured NC protocols. Embodiments described herein are not limited to radio bearer/PDCP configuration and are applicable to any type of network protocol configuration.

Embodiments described herein are not limited to NC configuration being configured by RRC (e.g., only). NC configurations configured through any of downlink control information (DCI), MAC control element (CE), layer 1 and/or layer 2 signal may be applicable to embodiments described herein.

In another example, the NC configuration(s) may pre-defined (e.g., in the technical specification), and may be pre-configured in the WTRU (e.g., the WTRU may not receive any configuration information indicating the NC configuration(s)).

It some other examples, the coefficient matrix(es) may be pre-defined (e.g., in the technical specification), and may be pre-configured in the WTRU.

In one example, one of the multiple NC configurations may be indicated as a default NC configuration. The WTRU may apply the default NC configuration for a NC process based on the NC process being initiated and/or activated.

A coefficient matrix configuration included in a NC configuration described herein may carry one or more of (i) a coefficient matrix index, (ii) a (set of) coefficient vector index(es), (iii) a (set of) row index(es) of a coefficient matrix, and (iv) a (set of) column index (ex) of a coefficient matrix.

For example, if a WTRU switches to a (e.g., second) NC configuration for a NC process, the WTRU may apply a coefficient matrix indicated by a coefficient matrix index included in the (e.g., second) NC configuration.

For example, if a WTRU switches to a (e.g., second) NC configuration for a NC process, the WTRU may apply a (set of) coefficient vector(s) indicated by a (set of) coefficient vector index(es) included in the (e.g., second) NC configuration.

For example, if a WTRU switches to a (e.g., second) NC configuration for a NC process, the WTRU may apply a (set of) row(s) of a coefficient matrix indicated by a (set of) coefficient row indexes included in the (e.g., second) NC configuration.

For example, if a WTRU switches to a (e.g., second) NC configuration for a NC process, the WTRU may apply a (set of) column(s) of a coefficient matrix indicated by a (set of) coefficient column indexes included in the (e.g., second) NC configuration.

The condition configuration included in a NC configuration described herein may include one or more of (i) a missing SDU percentage threshold, (ii) a missing SDU accumulation threshold, (iii) a missing SDU detection duration and (iv) a NC configuration switching prohibit duration, as described herein.

In an example, a missing SDU percentage threshold may be represented as a threshold of number (e.g., percentage) of missing SDU(s).

In an example, a missing SDU accumulation threshold may be represented as a threshold of number of (e.g., missing SDU) events. For example, (e.g., missing SDU) events may be counted by a missing SDU event counter. A (e.g., missing SDU) event may refer to an event where the number (e.g., percentage) of missing SDU(s) may exceed (or be equal to) the missing SDU percentage threshold.

In an example, a missing SDU detection duration may be represented as a time duration over which the WTRU may count/determine (e.g., based on the missing SDU event counter) the number of times the missing SDU event may occur.

In an example, a NC configuration switching prohibit duration may be represented as a time duration over which the WTRU may avoid evaluating NC configuration switching or a time duration over which the WTRU may be prohibited to perform NC state (configuration) transition (e.g., switching).

In an example, the NC configuration index included in a NC configuration described herein may be an index associated with the NC configuration.

In another example, the NC configuration index may not be explicitly included in the NC configuration. The NC configuration index may be derived based on the order of the NC configuration within the multiple NC configurations included in a RRC message. For example, the RRC message may indicate three NC configuration. The first NC configuration may be implicitly determined as a NC configuration with NC configuration index one, the second NC configuration may be implicitly determined as a NC configuration with NC configuration index two, and the third NC configuration may be implicitly determined as a NC configuration with NC configuration index three.

### Default NC Configuration

In an example, among the configured multiple NC configurations, one of the multiple NC configurations may be indicated as a default NC configuration.

For example, one of the multiple NC configurations may be a default NC configuration. The default NC configuration may be indicated by an explicitly indicator or may be implicitly identified by the WTRU based on the order of the NC configuration within the multiple NC configurations.

In an example of explicit approach, the WTRU may receive an information element indicating a NC configuration index. A NC configuration associated with the NC configuration index may be determined as a default NC configuration.

In an example of implicit approach, among the configured multiple NC configurations, the WTRU may identify one of the multiple NC configurations as a default NC configuration based on the order or the index (e.g., NC configuration index) of the NC configuration. For example, the first or the last NC configuration within the multiple NC configurations may be determined by the WTRU as the default NC configuration. In another example, the NC configuration with smallest or largest NC configuration index value may be determined as the default NC configuration.

### Identification of PDU

In an example, a transmitting WTRU may assign an order sequence number (SN) to a PDU based on a type of the PDU and based on an order of the PDU within a NC PDU set. The transmitting WTRU may assign a NC PDU set SN to a (e.g., each) PDU based on an association of the PDU with the NC PDU set.

A NC encoding process may be performed at a transmitting WTRU by using a NC generation. The NC encoding process may generate multiple PDUs. The multiple PDUs may refer to a NC PDU set in embodiments described herein. For example, the NC PDU set may contain multiple PDUs.

To assist a receiving WTRU identifying an order of a PDU within a NC PDU set, the transmitting WTRU may assign an order SN to the PDU. To assist the receiving WTRU identifying an association of a PDU with the NC PDU set, the transmitting WTRU may assign a NC PDU set SN to the PDU. A (e.g., each) PDU within the NC PDU set may be assigned with an order SN and a NC PDU set SN.

A value of an order SN assigned to a PDU may be determined based on the order of the PDU within a NC PDU set to which the PDU may belong. A value of a NC PDU set SN assigned to the PDU may be determined based on an association of the PDU with the NC PDU set to which the PDU may belong.

For example, to assist a receiving WTRU in identifying an order within a NC PDU set of (e.g., each) received PDUs, the order SN assigned to the received PDUs may have different values. To assist the receiving WTRU in identifying the association with NC PDU set for the received PDUs, the NC PDU set SN assigned to the received PDUs may have a common value.

In one example, the value of the NC PDU set SN may be set to the value of the NC PDU set identifier.

### State-Based NC Configuration Switching

In an example, an active NC process may be operated in different NC states, and a (e.g., each) state may be configured to be associated with a NC configuration. A NC process may apply a NC configuration associated with a NC state when (e.g., while) the NC process may be in the NC state.

A NC process may be an active NC process after the NC process may have been initiated and before it may be released.

An active NC process may be operated in a first state, which may be referred to as General_NC state or in a second state, which may be referred to as an Aggressive_NC state. For example, the Aggressive_NC state may be associated with more robust NC coding than the General_NC state).

In one example, the WTRU may be configured by the gNB with a first NC configuration to be associated with the General_NC state and the WTRU may be configured by the gNB with a second NC configuration to be associated with the Aggressive_NC state. The first NC configuration may include a first coefficient matrix configuration, a first condition configuration and a first NC configuration index. The second NC configuration may include a second coefficient matrix configuration, a second condition configuration and a second NC configuration index. The first NC configuration may be different from the second NC configuration. For example, a first coefficient matrix indicated by the first NC configuration may be different from a second coefficient matrix indicated by the second NC configuration. For example, the first coefficient matrix may result in more robust coding rate than the second coefficient matrix.

When the NC process is in General_NC state, the WTRU may apply the first NC configuration to the NC process. For example, the NC process may apply a (subset of a) coefficient matrix indicated by the first coefficient matrix configuration. When the NC process is in the Aggressive_NC state, the WTRU may apply the second NC configuration to the NC process. For example, the NC process may apply a (subset of a) coefficient matrix indicated by the second coefficient matrix configuration.

After the NC process may be initiated, the NC process may be operated in any one of the General_NC state or Aggressive_NC state. For example, after a NC process may be initiated, the NC process may be operated in General_NC state until the WTRU may determine to transition from the General_NC state to the Aggressive_NC state.

For example, the WTRU may switch from a first NC configuration to a second NC configuration applied for a NC process based on a transition from a first NC state to a second NC state, wherein the first NC configuration may be (e.g., configured to be) associated with the first NC state and the second NC configuration may be (e.g., configured to be) associated with the second NC state.

In an example, a transition of a NC state may be triggered based on at least the condition configurations and/or SDU receiving status.

A WTRU may be configured by the gNB with a first NC configuration to be associated with the General_NC state and may be configured by the gNB with a second NC configuration to be associated with the Aggressive_NC state. The first NC configuration may include at least a first condition configuration and the second NC configuration may include at least a second condition configuration. For example, the first condition configuration may be associated with the General_NC state, and the second condition configuration may be associated with the Aggressive_NC state.

The NC process may transition from the General_NC state to the Aggressive_NC state or from the Aggressive_NC state to the General_NC state. For example, when the NC process is in the General_NC state, the WTRU may determine whether to perform the transition of the NC process to the Aggressive_NC state based on at least the second condition configuration. When the NC process is in Aggressive_NC state, the WTRU may determine whether to perform the transition of the NC process to General_NC state based on at least the first condition configuration.

For example, a NC configuration switching for a NC process may be triggered by the NC state transition.

For example, a NC configuration switching (e.g., from a source NC configuration to a target NC configuration) for a NC process may be triggered by the NC state transition based on a condition configuration. The condition configuration may be a condition associated with any of the source NC configuration and the target NC configuration.

In another example, while applying a first coefficient matrix associated with a first NC configuration for a NC process, a WTRU may determine whether to apply a second NC coefficient matrix associated with a second coefficient matrix configuration for the NC process. The determination may be performed based on a condition configuration associated with the first NC configuration.

As described herein, a condition configuration of a NC configuration may include one or more parameters. For example, the parameter may include any of a missing SDU percentage threshold, a missing SDU accumulation threshold, a missing SDU detection duration, and a NC configuration switching prohibit duration. The WTRU may determine whether to transition from the current NC state to another NC state based on a condition configuration associated with the other NC state. For example, the WTRU may apply a first coefficient matrix associated with a first NC configuration (associated with the current NC state) for a NC process. The WTRU may determine whether to apply a second NC coefficient matrix associated with a second coefficient matrix configuration (associated with the other NC state) for the NC process. The determination may be performed made based on a condition configuration associated with the second NC configuration.

In another example, The WTRU may apply a first coefficient matrix associated with a first NC configuration (associated with the current NC state) for a NC process. The WTRU may determine whether to apply a second NC coefficient matrix associated with a second coefficient matrix configuration (associated with the other NC state) for the NC process. The determination may be performed based on a condition configuration associated with the first NC configuration.

In one example, the WTRU may determine whether to transition from a first NC state to a second NC for a NC process based on any of (i) a condition configuration of a NC configuration of the first NC state (a condition configuration associated with the NC configuration and the first NC state), (ii) a condition configuration of a NC configuration of the second NC state (a condition configuration associated with the NC configuration and the second NC state), (iii) one or more received PDCP status reports, and (iv) a number of missing or success received SDUs indicated in one or more PDCP status reports.

In an example, a missing SDU percentage threshold may be configured by the gNB. The WTRU may determine to perform NC state transition for a NC process based on the missing SDU percentage threshold. For example, the WTRU may determine to transition from a first NC state to a second NC state based on the missing SDU percentage threshold. For example, the WTRU may determine to transition from a first NC state to a second NC stated for a NC process based on a missing SDU percentage threshold (e.g., configured to be) associated with the first NC state (configuration). In another example, the WTRU may determine to transition from a first NC state to a second NC stated for a NC process based on a missing SDU percentage threshold (e.g., configured to be) associated with the second NC state (configuration). More specifically, the WTRU may determine to transition from a first NC state to a second NC state for a NC process based on SDU receiving status and the missing SDU percentage threshold (e.g., configured to be) associated with the first NC state. In another example, the WTRU may determine to transition from a first NC state to a second NC state for a NC process based on SDU receiving status and the missing SDU percentage threshold (e.g., configured to be) associated with the second NC state. The WTRU may determine to transition from a first NC state to a second NC state for a NC process based on missing SDU event.

In a first example, the WTRU may receive one or more PDCP status reports, a (e.g., each) PDCP status report indicating one or more missing SDUs. The WTRU may determine to transition to the second NC state for a NC process based on the number of missing SDUs indicated in PDCP status report(s) and the missing SDU percentage threshold. For example, the WTRU may determine to transition to the second NC state for the NC process based on a comparison of the number of missing SDUs indicated in PDCP status report(s) and the missing SDU percentage threshold.

In a second example, the WTRU may receive one or more PDCP status reports, a (e.g., each) PDCP status report indicating one or more missing SDUs. The WTRU may determine to transition to the second NC state for a NC process if the number of missing SDUs indicated in a PDCP status report is equal to or greater than the missing SDU percentage threshold.

In an example, a missing SDU percentage threshold and a missing SDU accumulation threshold may be configured by the gNB. The WTRU may determine to perform NC state transition for a NC process based on the missing SDU percentage threshold and a missing SDU accumulation threshold. For example, the WTRU may determine to transition from a first NC state to a second NC state based on the missing SDU percentage threshold and a missing SDU accumulation threshold. For example, the WTRU may determine to transition from a first NC state to a second NC state for a NC process based on SDU receiving status, the missing SDU percentage threshold and the missing SDU accumulation threshold (e.g., configured to be) associated with the first NC state. In another example, the WTRU may determine to transition from a first NC state to a second NC state for a NC process based on SDU receiving status, the missing SDU percentage threshold and the missing SDU accumulation threshold (e.g., configured to be) associated with the second NC state. The WTRU may determine to transition from a NC state to a (e.g., specific) NC state for a NC process based on the missing SDU events.

In a first example, the WTRU may receive one or more PDCP status reports, a (e.g., each) PDCP status report indicating one or more missing SDUs. The WTRU may determine to transition to the second NC state for a NC process based on the number of missing SDUs indicated in the one or more PDCP status report(s), the missing SDU percentage threshold and the missing SDU accumulation threshold.

In a second example, the WTRU may receive one or more PDCP status reports, a (e.g., each) PDCP status report indicating one or more missing SDUs. The WTRU may accumulate the number of specific PDU status reports received, wherein the specific PDCP status report may refer to a PDCP status report indicating a number of missing SDUs that may satisfy a condition (e.g., the number of missing SDUs may be equal to or greater than the missing SDU percentage threshold).

In a third example, the WTRU may receive one or more PDCP status reports, a (e.g., each) PDCP status report indicating one or more missing SDUs. The WTRU may accumulate the number of specific PDCP status reports received, wherein the specific PDCP status report may refer to a PDCP status report indicating a number of missing SDUs that may satisfy a condition (e.g., the number of missing SDUs may be equal to or greater than the missing SDU percentage threshold). The WTRU may determine to transition to the second NC state for a NC process if the accumulated number is equal to or greater than the missing SDU accumulation threshold.

In an example, a missing SDU percentage threshold, a missing SDU accumulation threshold and a missing SDU detection duration may be configured by the gNB. The WTRU may determine to perform NC state transition for a NC process based on the missing SDU percentage threshold, the missing SDU accumulation threshold and the missing SDU detection duration. For example, the WTRU may determine to transition from a first NC state to a second NC state based on the missing SDU percentage threshold, the missing SDU accumulation threshold and the missing SDU detection duration. For example, the WTRU may determine to transition from a first NC state to a second NC stated for a NC process based on the missing SDU percentage threshold, the missing SDU accumulation threshold and the missing SDU detection duration (e.g., configured to be) associated with the first NC state (configuration). In another example, the WTRU may determine to transition from a first NC state to a second NC stated for a NC process based on the missing SDU percentage threshold, the missing SDU accumulation threshold and the missing SDU detection duration (e.g., configured to be) associated with the second NC state (configuration). More specifically, the WTRU may determine to transition from a first NC state to a second NC state for a NC process based on SDU receiving status, the missing SDU percentage threshold, the missing SDU accumulation threshold and the missing SDU detection duration (e.g., configured to be associated) with the first NC state. In another example, the WTRU may determine to transition from a first NC state to a second NC state for a NC process based on SDU receiving status, the missing SDU percentage threshold, the missing SDU accumulation threshold and the missing SDU detection duration (e.g., configured to be) associated with the second NC state. The WTRU may determine to transition from a NC state to another NC state for a NC process based on missing SDU accumulation event.

In a first example, the WTRU may receive one or more PDCP status reports, a (e.g., each) PDCP status report indicating one or more missing SDUs. The WTRU may determine to transition to the second NC state for a NC process based on the number of missing SDUs indicated in PDCP status report(s), missing SDU percentage threshold, missing SDU accumulation threshold and the missing SDU detection duration.

In a second example, the WTRU may receive one or more PDCP status reports, a (e.g., each) PDCP status report indicating one or more missing SDUs. Within a time duration indicated by the missing SDU detection duration, the WTRU may accumulate the number of specific PDCP status reports received, wherein the specific PDCP status report may refer to a PDCP status report indicating a number of missing SDUs that may satisfy a condition (e.g., may be equal to or greater than the missing SDU percentage threshold).

In a third example, the WTRU may receive one or more PDCP status reports, a (e.g., each) PDCP status report indicating one or more missing SDUs. The WTRU may accumulate, within a time duration indicated by the missing SDU detection duration, the number of specific PDCP status reports received, wherein the specific PDCP status report may refer to a PDCP status report indicating a number of missing SDUs satisfying a condition (e.g., the number of missing SDUs may be equal to or greater than the missing SDU percentage threshold). The WTRU may determine to transition to the second NC state for a NC process if the accumulated number is equal to or greater than the missing SDU accumulation threshold.

In an example, a missing SDU percentage threshold and a missing SDU detection duration may be configured by the gNB. The WTRU may determine to perform NC state transition for a NC process based on the missing SDU percentage threshold and the missing SDU detection duration. For example, the WTRU may determine to transition from a first NC state to a second NC state based on the missing SDU percentage threshold and the missing SDU detection duration. For example, the WTRU may determine to transition from a first NC state to a second NC stated for a NC process based on the missing SDU percentage threshold and the missing SDU detection duration (e.g., configured to be) associated with the first NC state (configuration). In another example, the WTRU may determine to transition from a first NC state to a second NC stated for a NC process based on the missing SDU percentage threshold and the missing SDU detection duration (e.g., configured to be) associated with the second NC state (configuration). For example, the WTRU may determine to transition from a first NC state to a second NC state for a NC process based on SDU receiving status and the missing SDU percentage threshold and the missing SDU detection duration (e.g., configured to be) associated with the first NC state. In another example, the WTRU may determine to transition from a first NC state to a second NC state for a NC process based on SDU receiving status and the missing SDU percentage threshold and the missing SDU detection duration (e.g., configured to be) associated with the second NC state.

In a first example, the WTRU may receive one or more PDCP status reports, a (e.g., each) PDCP status report indicating one or more missing SDUs. The WTRU may determine to transition to the second NC state for a NC process based on the number of missing SDUs indicated in PDCP status report(s), the missing SDU percentage threshold and the missing SDU detection duration.

In a second example, the WTRU may receive one or more PDCP status reports, a (e.g., each) PDCP status report indicating one or more missing SDUs. Within a time duration indicated by the missing SDU detection duration, the WTRU may accumulate (e.g., determine) the number of specific PDU status reports received, wherein the specific PDCP status report may refer to a PDCP status report indicating a number of missing SDUs satisfying a condition (e.g., the number of missing SDUs may be equal to or greater than the missing SDU percentage threshold (e.g., zero)).

In a third example, the WTRU may receive one or more PDCP status reports, a (e.g., each) PDCP status report indicating one or more missing SDUs. The WTRU may accumulate (e.g., determine), within a time duration indicated by the missing SDU detection duration, the number of specific PDCP status reports received, wherein the specific PDCP status report may refer to a PDCP status report indicating a number of missing SDUs satisfying a condition (e.g., the number of missing SDUs may be equal to or greater than the missing SDU percentage threshold). The WTRU may determine to transition to the second NC state for a NC process if the accumulated number is equal to or lower than a threshold.

### Rule-Based NC Configuration Switching

Rule-based NC configuration switching is described herein.

### First Example of Rule-Based NC Configuration Switching.

In the first example, a WTRU may be configured with multiple NC configurations. The WTRU may determine to switch to a NC configuration based on a received NC configuration switching indicator.

A WTRU may be configured with multiple NC configurations. The WTRU may determine whether to apply a NC configuration based on at least an NC configuration switching indicator. The NC configuration switching indication may include (e.g., indicate) at least an identification of the NC configuration. For example, a WTRU may determine to switch to a NC configuration for a NC process based on (e.g., in response to) receiving (e.g., information indicating) a NC configuration switching indicator. For example, a WTRU may determine to switch to a specific NC configuration for a NC process based on (e.g., in response to) receiving (e.g., information indicating) a NC configuration switching indicator, wherein the NC configuration switching indicator may indicate the specific NC configuration.

In one example, after receiving a NC configuration switching indicator, the WTRU may perform the NC configuration switching e.g., immediately.

In another example, after receiving a NC configuration switching indicator, the WTRU may perform the NC configuration switching after a hybrid automatic repeat request (HARQ) feedback corresponding the NC configuration switching indicator reception may have been transmitted.

### Second Example of Rule-Based NC Configuration Switching

In the second example, the NC configuration switching indicator may include a NC process field which may indicate a NC process which NC configuration may be switched.

In one example, a NC configuration switching indicator may contain a NC process field which may indicate a NC process which NC configuration may be switched. For example, the WTRU may determine to switch to a specific NC configuration for a NC process based on (e.g., in response to) receiving (e.g., information indicating) a NC configuration switching indicator indicating the specific NC configuration. The NC configuration switching indicator may include a NC process field indicating the NC process.

### Third Example of Rule-Based NC Configuration Switching

In the third example, the NC configuration switching indicator may include any of a NC PDU set SN field and a NC SDU set SN field which may indicate when a NC configuration may be switched.

In an example, a NC configuration switching indicator may include a NC process field which may indicate a NC process which NC configuration may be switched. The NC configuration switching indicator may (e.g., also) include a NC PDU set SN field (or a NC SDU set SN field) which may indicate that the NC configuration may be applied by the NC process starting when generating a PDU with a NC PDU set SN indicated by NC PDU set SN field (or starting when processing a SDU with a NC SDU set SN indicated by NC SDU set SN field). For example, the WTRU may determine to switch to a specific NC configuration for a NC process starting when generating a PDU with a NC PDU set SN indicated by NC PDU set SN field (or starting when processing a SDU with a NC SDU set SN indicated by NC SDU set SN field) based on (e.g., in response to) receiving a NC configuration switching indicator, wherein the NC configuration switching indicator may indicate the specific NC configuration, wherein the NC configuration switching indicator may include a NC process field indicating the NC process, and wherein the NC configuration switching indicator may include a NC PDU set SN field (or a NC SDU set SN field).

In an example, the NC configuration switching indicator may be a PDCP entity specific indicator. For example, the NC configuration switching indicator may indicate a NC configuration which may be applied by the WTRU for a PDCP entity. Different NC configuration switching indicators received by the WTRU may be applied for different NC processes belonging to different PDCP entities. In one example, the WTRU may receive the NC configuration switching indicator for a PDCP entity, the WTRU may determine to switch the NC configuration for (e.g., all) NC processes associated with the PDCP entity.

In another example, the NC configuration switching indicator may be a cell group specific indicator. For example, the NC configuration switching indicator may indicate multiple NC configurations e.g., at a time. A (e.g., each of the) multiple NC configurations may be for a PDCP entity associated with a radio bearer belonging to the cell group. For example, the NC configuration switching indicator may include multiple fields, where a field (e.g., each field) may indicate a NC configuration (e.g., via a NC configuration index). A field (e.g., each field) may be applied by a PDCP entity of the cell group. The association between a field and a PDCP entity may be based on the position of the field within the NC configuration switching indicator. For example, the first field may be associated with a PDCP entity which may be associated with a radio bearer with smallest radio bearer ID. The second field may be associated with a PDCP entity which may be associated with a radio bearer with second smallest radio bearer ID. In another example, a field (e.g., each field) may be bundled with another PDCP indicator indicating the PDCP entity to which the field may apply.

In another example, the NC configuration switching indicator may be a WTRU specific indicator. For example, the NC configuration switching indicator may indicate multiple NC configurations e.g., at a time. One (e.g., each) of the multiple NC configurations may be for a PDCP entity configured for the WTRU.

In embodiments described herein, a WTRU switching from a first NC configuration to a second NC configuration may be referred to as a WTRU switching from a first NC configuration to a second NC configuration for a NC process. For example, the WTRU may be applying a first NC configuration for a NC process, and (e.g., after switching) the WTRU may be applying a second NC configuration for the NC process.

### Fourth Example of Rule-Based NC Configuration Switching

In the fourth example, a WTRU may be configured with multiple NC configurations. The WTRU may determine to switch to a NC configuration based on reference signal measurement.

A WTRU may be configured with multiple NC configurations. The WTRU may determine whether to apply a NC configuration based on at least a measurement result and e.g., one or more threshold indicated by the condition configuration of the NC configuration.

In one example, a first threshold (e.g., a reference signal receive power (RSRP) threshold) may be configured by a condition configuration of a NC configuration. The WTRU may perform a reference signal measurement and may determine whether to switch to the NC configuration based on the measurement result and the first (e.g., RSRP) threshold. In one example, the WTRU may determine to switch to the NC configuration if the measurement result satisfies a strength condition (e.g., is equal to or greater than the RSRP threshold). In another example, the WTRU may determine to switch to the NC configuration if the measurement result fails to satisfy a strength condition (e.g., is lower than the RSRP threshold).

In other examples, the WTRU may determine to switch to the NC configuration if the measurement result is lower than the RSRP threshold for a period of time, where the period of time may be any of pre-defined and pre-configured by the gNB.

### Fifth Example of Rule-Based NC Configuration Switching

In the fifth example, a WTRU may be configured with multiple NC configurations. The WTRU may determine to switch to a NC configuration for a NC process based on a PDU forwarding method applied by a PDCP entity which the NC process may be associated with.

The rule to apply a NC configuration for a NC process may be based on how a PDU may be forwarded to the lower layer by a PDCP entity which the NC process may be associated with. The rules may be (e.g., without limitation) according to at least one of the following examples of rules.

In a first example of rule, a NC configuration may be applied for a NC process if a specific PDU submission method is (indicated to be) applied by a PDCP entity associated with the NC process. In one example, the WTRU may be configured, by a gNB, with a (e.g., specific) PDU submission method identifier via a condition configuration associated with the NC configuration. For example, the condition configuration may indicate the PDU submission method identifier.

In a second example of rule, a NC configuration may be applied for a NC process associated with a PDCP entity if a specific RLC bearer is associated with the PDCP entity. In one example, the WTRU may be configured, by a gNB, with a (e.g., specific) RLC bearer identity via a condition configuration associated with the NC configuration. For example, the condition configuration may indicate the RLC bearer identity (e.g., identifier).

In a third example of rule, a NC configuration may be applied for a NC process associated with a PDCP entity if a specific RLC entity is associated with the PDCP entity. In one example, the WTRU may be configured, by a gNB, with a specific RLC entity identity via a condition configuration associated with the NC configuration. For example, the condition configuration may indicate the RLC entity identity (e.g., identifier).

In a fourth example of rule, a NC configuration may be applied for a NC process associated with a PDCP entity if a specific set of RLC bearers are associated with the PDCP entity. In one example, the WTRU may be configured, by a gNB, with a specific set of RLC bearer identities via a condition configuration associated with the NC configuration. For example, the condition configuration may indicate the set of RLC bearer identities (e.g., identifiers).

In a fifth example of rule, a NC configuration may be applied for a NC process associated with a PDCP entity if a specific set of RLC entities are associated with the PDCP entity. In one example, the WTRU may be configured, by a gNB, with a specific set of RLC entity identities via a condition configuration associated with the NC configuration. For example, the condition configuration may indicate the set of RLC entity identities (e.g., identifiers).

In a sixth example of rule, a NC configuration may be applied for a NC process associated with a PDCP entity if the number of (activated) associated RLC entity is equal to or larger or less than a threshold. In one example, the WTRU may be configured, by a gNB, with a (e.g., specific) RLC entity activation number threshold (e.g., indicating a number activated RLC entity) via a condition configuration associated with the NC configuration. For example, the condition configuration may indicate the RLC entity activation number threshold.

In a seventh example of rule, a NC configuration may be applied for a NC process associated with a PDCP entity if the number of (activated) associated RLC entity is within a range.

In one example, the WTRU may be configured, by a gNB, with a (e.g., specific) RLC entity activation number range (e.g., indicating a number activated RLC entity) via a condition configuration associated with the NC configuration. For example, the condition configuration may indicate the RLC entity activation number range.

### Sixth Example of Rule-Based NC Configuration Switching

In the sixth example, a WTRU may be configured with multiple NC configurations. The WTRU may determine to switch to a NC configuration for a NC process based on a type of UL grant received by the WTRU.

In one example, the WTRU may receive uplink grant (e.g., information) for the PDU transmission. The uplink grant (e.g., information) may be received via one or more DCI transmitted on physical downlink control channel (PDCCH) from a gNB. In an example, a different DCIs may have different types of formats. The WTRU may receive one or more DCIs with different formats indicating uplink resources on physical uplink shared channel (PUSCH). In one example, uplink resources may (e.g., only) be used for the PDU transmission (generated by the NC process).

A (e.g., each (set of)) format(s) of the DCI may be associated with a NC configuration indicated by the condition configuration (e.g., the condition configuration may indicate one or more DCI formats associated with the NC configuration). The WTRU may determine which NC configuration may be to be applied for a NC process based on which format(s) of DCI may be received.

In some other examples, via a condition configuration, the WTRU may be configured with an association between a NC configuration and a type of radio network temporary identifier (RNTI). For example, the WTRU may receive one or more DCIs with CRC bits scrambled by different types of RNTI. The WTRU may determine which NC configuration may be to be applied for a NC process based on which type of RNTI may be applied to be scrambled with the CRC bits of the received DCI.

### NC Configuration Switching Confirmation

In an example, after the WTRU may have switched a NC configuration, the WTRU may transmit a NC configuration switching confirmation to gNB. The NC configuration switching confirmation may include (e.g., indicate) a NC configuration index and/or NC PDU (SDU) set SN.

In an example, after the WTRU may have switched from a first NC configuration to a second NC configuration for a NC process, the WTRU may transmit (e.g., information indicating) a NC configuration switching confirmation to the gNB. The switching from the first NC configuration to the second NC configuration may be triggered based on any of a state-based method or a rule-based method. Triggering the switching from the first NC configuration to the second NC configuration based on any other method is applicable to embodiments described herein.

In one example, a WTRU may receive a NC configuration switching indication from the gNB as the WTRU may be applying a first NC configuration for a NC process. The WTRU may switch from a first NC configuration to a second NC configuration for the NC process. For example, the WTRU may apply the second NC configuration after having received the NC configuration switching indication. Based on (e.g., in response to) switching from the first NC configuration to the second NC configuration, the WTRU may transmit (e.g., information indicating) a NC configuration switching confirmation to gNB. If the switching from the first NC configuration to the second NC configuration cannot be accomplished (e.g., by the WTRU), the WTRU may transmit (e.g., information indicating) the NC configuration switching failure e.g., in the NC configuration switching confirmation or the WTRU may skip the transmission of the NC configuration switching confirmation.

In another example, a WTRU may receive a NC configuration switching indication from the gNB as a NC process may be in a first NC state, and the WTRU may be applying a first NC configuration (associated with the first NC state) for the NC process. The NC process may transition to a second NC state, and the WTRU may switch from the first NC configuration to a second NC configuration (associated with the second NC state) for the NC process. For example, the WTRU may apply the second NC configuration after having received the NC state transition. Based on (e.g., in response to) switching from the first NC configuration to the second NC configuration, the WTRU may transmit (e.g., information indicating) a NC configuration switching confirmation to gNB.

In some other examples, a WTRU may be configured with a first NC configuration and a second NC configuration. The first NC configuration may be carried with a first condition configuration, and the second NC configuration may be carried with a second condition configuration. As the WTRU may apply the first NC configuration for a NC process, the WTRU may determine whether to switch from the first NC configuration to the second NC configuration based on at least any of the first condition configuration and the second condition configuration. After the WTRU may have determined to switch to the second NC configuration, the WTRU may apply the second NC configuration for the NC process. For example, the WTRU may apply the second NC configuration for the NC process after determining to switch to the second NC configuration. Based on (e.g., in response to) switching from the first NC configuration to the second NC configuration, the WTRU may transmit (e.g., information indicating) a NC configuration switching confirmation to gNB.

The NC configuration switching confirmation may be included in any of a PDCP control PDU, a PDCP PDU carrying a specific sub-header and a MAC CE.

The NC configuration switching confirmation may include (e.g., indicate) at least any of (i) a NC configuration index, (ii) a NC PDU set SN, (iii) a NC SDU set SN.

For example, based on (e.g., in response to) the WTRU switching from a first NC configuration to a second NC configuration, the WTRU may transmit (e.g., information indicating) a NC configuration switching confirmation indicating a NC configuration index to a gNB, wherein the NC configuration index may be associated with the second NC configuration.

In another example, based on (e.g., in response to) the WTRU switching from a first NC configuration to a second NC configuration for a NC process, and the NC process starting to apply the second NC process when processing a PDU with a NC PDU set SN, the WTRU may transmit a NC configuration switching confirmation indicating a NC configuration index and the NC PDU set SN to a gNB, wherein the NC configuration index may be associated with the second NC configuration.

In yet another example, based on (e.g., in response to) the WTRU switching from a first NC configuration to a second NC configuration for a NC process, and the NC process starting to apply the second NC configuration when processing a SDU with a NC SDU set SN, the WTRU may transmit a NC configuration switching confirmation indicating a NC configuration index and the NC SDU set SN to a gNB, wherein the NC configuration index may be associated with the second NC configuration.

In an example, after the WTRU may have switched NC configuration, the WTRU may clear the NC context, and/or release NC process.

Based on (e.g., in response to) a transmitting WTRU switching from a first NC configuration to a second configuration for a NC process, the transmitting WTRU may clear the stored NC context for the NC configuration. For example, the transmitting WTRU may determine to establish a new NC context based on the second configuration.

In an example, a receiving WTRU may have received a first PDU belonging to a NC PDU set, and the first PDU may have been generated by using a first NC configuration. The receiving WTRU may receive a second PDU belonging to the NC PDU set, and the second PDU may have been generated by using a second NC configuration. The WTRU may clear the NC context which may have been created based on at least the first PDU.

### Preventing Frequent NC Configuration Switching

In an example, after the WTRU may have switched NC configuration, the WTRU may be prohibited to switch NC configuration within a period of time.

In order to avoid a WTRU switching among different NC configurations frequently, the WTRU may not be allowed (e.g., may be prohibited) to switch to another NC configuration within a period of time after the switch to a NC configuration. The switching from a NC configuration to another NC configuration may be triggered based on any of a state-based method, a rule-based method, or any other method as described herein.

For example, after a WTRU may have determined to switch NC configuration (e.g., switching from a first NC configuration to a second NC configuration based on any of a first condition configuration associated with the first NC configuration and a second condition configuration associated the second NC configuration), the WTRU may check whether a time duration between this NC configuration switching and a (e.g., previous) NC configuration switching executed in last time may satisfy a time condition (e.g., may be longer than a duration threshold). The duration threshold may be, for example, a NC configuration switching prohibit duration associated with any of the first and the second NC configuration. If the time duration is shorter than the duration threshold, the WTRU may not switch the NC configuration. For example, if the time duration is equal to or longer than the duration threshold, the WTRU may switch the NC configuration, wherein the duration threshold may be pre-configured by a gNB.

In one example, the WTRU may start a prohibit timer after the WTRU may have switched from a first NC configuration to a second NC configuration. While the prohibit timer is running, the WTRU may be prohibited to perform NC configuration switching. An initial value of the prohibit timer may be set to a NC configuration switching prohibit duration which may have been pre-configured by the gNB via e.g., RRC signaling. For example, the NC configuration switching prohibit duration may be configured via the NC configuration. In an example, the NC configuration switching prohibit duration may be associated with the first NC configuration. In another example, the NC configuration switching prohibit duration may be associated with the second NC configuration.

In another example, while the prohibit timer is running, the WTRU may not transition a NC state of a NC process (e.g., even) if any NC state transition condition is satisfied. In another example, while the prohibit timer is running, the WTRU may not transition a NC state of a NC process (e.g., even) if any NC state transition condition is satisfied and may postpone the NC state transition until the prohibit timer may have expired.

In another example, the WTRU may start a prohibit timer after the WTRU may have switched from a first NC configuration to a second NC configuration. While the prohibit timer is running, the WTRU may stop the evaluation of condition for NC configuration switching. For example, the WTRU may skip counting the number of times the WTRU may receive a PDCP status report indicating the number missing SDUs above the missing SDU percentage threshold. In another example, the WTRU may skip counting the missing SDU events.

For example, after a WTRU may have finished a NC configuration switching, the WTRU may start to evaluate whether a NC configuration switching condition has been satisfied after a period of time. The period of time may have been pre-configured by the gNB. For example, the WTRU may start to count the number of times the WTRU may receive a PDCP status report indicating the number missing SDU above the missing SDU percentage threshold after the period of time.

### Control of Activation and Deactivation of Network Coding

Control of activation and deactivation of NC is described herein.

### First Example of NC Activation/Deactivation

In the first example, a WTRU with a NC protocol configured to a radio bearer may be indicated with an initial activation/deactivation state by a downlink RRC signaling. The activation/deactivation state may be changed dynamically by (e.g., additional) downlink layer two signaling (e.g., PDCP/MAC) and/or layer one signaling (e.g., DCI).

A method for a WTRU to determine to activate or deactivate a NC of a radio bearer is described herein.

The method may comprises receiving a downlink RRC message carrying a NC configuration associated with a radio bearer, wherein the NC configuration may indicate one or more of RLC entities associated with the NC.

The method may comprises determining to activate or deactivate the NC based on one or more of the following examples.

In a first example, determining to activate or deactivate may be based on a first activation/deactivation state indicator carried by the NC configuration.

In a second example, determining to activate or deactivate may be based on a second activation/deactivation state indicator that may be carried by any of (i) a downlink MAC CE, (ii) a control PDCP PDU, and (iii) a header of a PDCP PDU.

In a third example, determining to activate or deactivate may be based on a DCI with CRC bits scrambled by a specific type of RNTI (e.g., configured scheduling radio network temporary identifier (CS-RNTI)). The DCI may carry a new data indicator (NDI) with specific value and/or the DCI may be associated with a HARQ process which HARQ buffer may store data of the data radio bearer (DRB), which may be configured with survivalTimeStateSupport.

In a fourth example, determining to activate or deactivate may be based on activation/deactivation state of (e.g., each of) the one or more RLC entities indicated by the NC configuration and/or the downlink MAC CE.

In a case where the determination of the activation/deactivation of the NC is based on the downlink MAC CE, the method may further include (e.g., a MAC entity of) the WTRU indicating a PDCP entity associated with the NC to activate/deactivate the NC based on (e.g., in response) to the determination of the activation/deactivation of the NC.

In a case where the determination of the activation/deactivation of the NC is based on the activation/deactivation state of (e.g., each of) the one or more RLC entities, the method may further include (e.g., a MAC entity of) the WTRU indicating a PDCP entity associated with the NC to activate/deactivate corresponding RLC entities based on (e.g., in response to) the determination of the activation/deactivation of (e.g., each of) the one or more RLC entities.

In one example, the WTRU may receive a downlink MAC CE including multiple activation/deactivation status information, where one (e.g., each) of the multiple activation/deactivation status information may be associated with one of the multiple radio bearers configured with NC. The association between (e.g., each of) the multiple activation/deactivation status information and a radio bearer may be based on any of an associated radio bearer indicator and a position of the activation/deactivation status information within the MAC CE.

### Second Example of NC Activation/Deactivation

In the second example, the activation/deactivation state of a NC configured to a radio bearer may be determined based on a number of activated RLC entities associated with the NC.

In one example, the activation/deactivation determination may further include determining to activate the NC in case of a number of RLC entities indicated as activated is greater or equal to a threshold. The method may further include determining to deactivate the NC in case of a number of RLC entities indicated as activated is less than the threshold.

In another example, the WTRU may receive a downlink MAC CE carrying the activation/deactivation status of (e.g., each of) the one or more RLC entities. The WTRU may identify the downlink MAC CE associated with a radio bearer based on a radio bearer indicator carried by the downlink MAC CE.

### Third Example of NC Activation/Deactivation

In the third example, based on (e.g., in response to) the NC being determined to be deactivated, the MAC entity may indicate the PDCP entity to deactivate a second RLC entity.

For example, the MAC entity may indicate the PDCP entity to deactivate a second RLC entity based on (e.g., in response to) the NC being determined to be deactivated.

### Fourth Example of NC Activation/Deactivation

In the fourth example, a WTRU may be configured with multiple NC configurations for a NC protocol. One (e.g., each) of the multiple NC configuration may be dynamically activated/deactivated by layer two signaling (e.g., PDCP/MAC) and/or layer one signaling (e.g., DCI).

A transmitting and/or a receiving WTRU may be configured with multiple NC configurations. The multiple NC configurations may be received from a gNB. One (e.g., each) of the multiple NC configurations may have individual activation/deactivation status. For example, (e.g., only) activated NC configurations may be applied by the WTRU for NC process.

For example, a WTRU may be configured with multiple NC configurations for a NC process. One (e.g., each) of the multiple NC configurations may be activated or deactivated by any of a layer two and a layer one signaling. For example, (e.g., only) the NC configuration(s) which may be activated can be applied to the NC process.

In one example, if a NC state is associated with a NC configuration which may be deactivated, the WTRU may not be allowed to transition to the NC state.

In one example, after the WTRU may have received any of a layer two and a layer one signaling indicating activation or deactivation of a NC configuration, the WTRU may perform the NC configuration activation or deactivation e.g., immediately.

In one example, after the WTRU may have received any of a layer two and a layer one signaling indicating activation or deactivation of a NC configuration, the WTRU may perform the NC configuration activation or deactivation after a HARQ feedback corresponding the NC configuration switching indicator reception may have been transmitted.

In one example, after the WTRU may have received any of a layer two and a layer one signaling indicating deactivation of a NC configuration, the WTRU may perform the NC configuration deactivation after a NC process (which may apply the NC configuration) may have been successfully decoded.

### First Example of Network Coding Control

A first example of NC control is described herein.

A method for a WTRU to determine to switch a NC configuration applied for a radio bearer is described herein.

The method may include receiving, from a gNB, a RRC message carrying (e.g., indicating) a first NC configuration and a second NC configuration. In an example, (e.g., each of) the first NC configuration and the second NC configuration may indicate at least any of a coefficient matrix configuration and a condition configuration. For example, a coefficient matrix configuration may indicate at least a coefficient matrix (e.g., a set of coding coefficients) to be applied for a NC process. For example, a condition configuration may indicate one or more parameters to be used for NC configuration switching determination. In an example, the condition configuration of the first NC configuration may include any of a first missing SDU percentage threshold and a first NC configuration switching prohibit duration. In an example, the condition configuration of the second NC configuration may include any of a second missing SDU percentage threshold, a missing SDU accumulation threshold, a missing SDU detection duration and a second NC configuration switching prohibit duration.

The method may include receiving one or more PDCP status reports, from the gNB, (e.g., each) indicating a number of missing SDUs.

In a case where the first NC configuration is applied for a NC process, the method may include performing the NC process by applying the coefficient matrix configuration of the first NC configuration and performing a NC configuration switching determination procedure based on (e.g., in response to) receiving the one or more PDCP status report and based on at least the condition configuration of the second NC configuration. For example, the NC configuration switching determination procedure may include one or more operations according to one or more of the following examples.

In a first example, the method may include, if the number of missing SDUs is equal to or greater than the first missing SDU percentage threshold, and if a survival timer (associated with the second NC configuration) is not running, any of (i) setting an initial value of the survival timer to the missing SDU detection duration, (ii) starting the survival timer and (iii) performing a reset of a missing SDU event counter (e.g., initialization). The method may further include, if the survival timer is running, increasing the missing SDU event counter by one.

In a second example, the method may include, if the missing SDU event counter reaches the second missing SDU accumulation threshold, any of (i) stopping the survival timer, (ii) switching to the second NC configuration, (iii) transmitting a NC configuration switching confirmation to the gNB, wherein the NC configuration switching confirmation may indicate the second NC configuration being applied, and/or a PDU set SN of a PDU which may be a first PDU applying the second NC configuration, and (iv) setting an initial value of a prohibit timer to the second NC configuration switching prohibit duration, and starting the prohibit timer.

In a third example, the method may include performing a reset of the missing SDU event counter, if the survival timer expired.

In a case where the second NC configuration is applied for a NC process, the method may include performing the NC process by applying the coefficient matrix configuration of the second NC configuration and performing a NC configuration switching determination procedure based on (e.g., in response to) receiving the one or more PDCP status report and based on at least the condition configuration of the first NC configuration after the prohibit timer may have expired. For example, the NC configuration switching determination procedure may include one or more operations according to one or more of the following examples.

In a first example, the method may include, if the number of missing SDUs are less than the first missing SDU percentage threshold and if a NC configuration switching timer (associated with the first NC configuration) setting an initial value of the NC configuration switching timer to the NC configuration switching prohibit duration and starting the NC configuration switching timer.

In a second example, the method may include, if the number of missing SDUs are equal to or greater than the second missing SDU percentage threshold, stopping the NC configuration switching timer (e.g., if running).

In a third example, the method may include switching to the first NC configuration in response to the NC configuration switching timer having expired.

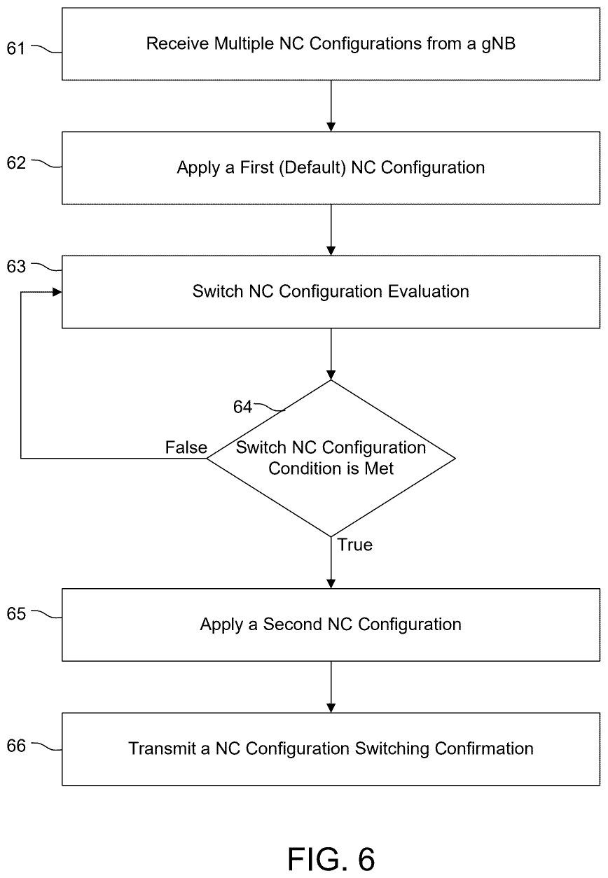

FIG. 6 is a diagram illustrating an example overall procedure of a NC configuration switching.

As shown at 61, the WTRU may receive (e.g., configuration information indicating) multiple NC configurations from the gNB. The NC configuration may be, for example, carried by a downlink RRC message. In an example, (e.g., each of) the multiple NC configurations may include any of (i) a coefficient matrix configuration indicating at least a coefficient matrix to be applied, (ii) a condition configuration indicating at least a parameter (which may be applied for evaluating whether to switch to the NC configuration) and (iii) a NC configuration index which may indicate an association with the NC configuration.

In one example, the WTRU may receive (e.g., configuration information indicating) multiple NC configurations and multiple condition configurations. For example, one (e.g., each) of the multiple NC configurations may be associated with at least one condition configuration. One (e.g., each) of the condition configurations may be associated with at least one NC configuration.

In another example, the WTRU may receive (e.g., configuration information indicating) multiple condition configurations. Several condition configurations may be grouped as a group condition configuration. The WTRU may be indicated by the gNB a NC configuration associated with the group condition configuration.

One of the multiple NC configurations may be indicated as a default NC configuration. In one example, the NC configuration with smallest NC configuration index may be implicitly indicated as a default NC configuration.

For example, the multiple NC configurations may include at least a first NC configuration and a second NC configuration. The first NC configuration may be indicated as a default NC configuration.

In embodiments described herein, the NC configuration may be, for example (and without limitation), a radio bearer/a PDCP specific configuration. For example, for different PDCP entities/radio bearers configured with NC protocol respectively, the gNB may provide individual NC configurations for (e.g., each of) the configured NC protocols.

As shown at 62, the WTRU may apply a first NC configuration for a NC process. In state-based NC configuration switching approach, the WTRU may enter in a first NC state. The WTRU may apply a first NC configuration for a NC process, wherein the first NC configuration may be associated with the first NC state.

In one example, for applying the first NC configuration, the WTRU may apply at least a coefficient matrix indicated by a coefficient matrix configuration to generate PDU(s).

In one example, as the WTRU may apply the first NC configuration, the WTRU may submit the generated PDU(s) to a first group of RLC entity(ies) e.g., indicated by the NC configuration. The coefficient matrix configuration may be associated with the first NC configuration and the coefficient matrix configuration may be carried by the first NC configuration.

As shown at 63, the WTRU determining whether to switch to a second NC configuration may be based on one or more of (i) a condition configuration of the second NC configuration, (ii) an NC configuration switching indicator and (iii) a reference signal measurement result.

For example, in state-based NC configuration switching, the WTRU may determine whether to switch to a second NC state based on at least a condition configuration associated with the second NC state.

For example, in state-based NC configuration switching approach, the WTRU may determine whether to switch to a second NC state based on at least a NC configuration switching indicator.

For example, in state-based NC configuration switching approach, the WTRU may determine whether to switch to a second NC state based on at least a reference signal measurement result.

After a WTRU may be configured with multiple NC configurations, the WTRU may switch NC configuration applied for a NC process based on any of a PDCP status report, a condition configuration and a NC configuration switching indicator. To prevent frequent NC configuration switching, a WTRU may be prohibited to switch NC configuration within a period of time after the WTRU may have switched NC configuration.

In one example, a WTRU may receive two NC configurations (e.g., a first NC configuration and a second NC configuration) from a gNB. The NC configurations may be carried by a downlink RRC message. One (e.g., each) of the two NC configurations may carry any of a coefficient matrix configuration indicating a coefficient matrix to be applied, a condition configuration indicating a condition to be applied for the NC configuration and a NC configuration index indicating an association with the NC configuration.

As the WTRU may be applying the first NC configuration for a NC process, the WTRU may determine that the condition of switching to the second NC configuration may be satisfied, the WTRU may switch from the first NC configuration to the second NC configuration, such that the second NC configuration may be applied.

The WTRU may apply a coding coefficient matrix indicated by a coefficient matrix configuration included in the second NC configuration to generate PDU(s). The WTRU may submit the generated PDU(s) to a second group of RLC entity(ies) indicated by the second NC configuration.

A PDCP status report may be received. The PDCP status report may indicate a number of SDUs that may be missing.

In a case where the number of missing SDUs is less than a missing SDU percentage threshold configured in the second NC configuration, or in a case where the missing SDU percentage is less than a missing SDU percentage threshold configured in the second NC configuration, the WTRU may start the NC configuration switching timer, e.g., if a NC configuration switching timer for the second NC configuration is not running.

In a case where the number of missing SDUs is equal to or greater than the missing SDU percentage threshold, or in case of a missing SDU event, the WTRU may stop the NC configuration switching timer for the second NC configuration e.g., if the NC configuration switching timer is running.

In response to the NC configuration switching timer expiring, the WTRU may determine whether the condition of switching to the first NC configuration may be satisfied, and/or the WTRU may switch to the first NC configuration.

In one example, the WTRU may start a (e.g., specific) timer after the WTRU may have switched to the second NC configuration. The WTRU may (e.g., start to) evaluate the conditions after the (e.g., specific) timer may have expired. For example, the WTRU may not be allowed to perform the evaluation of whether the conditions to switch NC configuration is satisfied or not (e.g., right) after the WTRU may have switched of NC configuration. The WTRU may start to evaluate the evaluation (e.g., only) after a period of time. The period of time may be starting from the time the WTRU switched of NC configuration and may have a length configured by the gNB.

In one example, the WTRU may determine whether a second NC state transition condition may have been satisfied. For example, the WTRU may determine whether a condition of transition to the second NC state may have been satisfied, wherein the determination may be implemented in one or more of the following examples.

### Example of Condition Determination Based on SDU Receiving Status

In an example, the WTRU may perform the determination (e.g., of whether a condition of transition to the second NC state may have been satisfied) based on a SDU receiving status.

In one example, the WTRU may receive one or more PDCP status report(s).

Based on (e.g., in response to) receiving a PDCP status report indicating a number of SDUs that may be missing, wherein the number of missing SDUs may satisfy a condition (e.g., may be equal to or greater than a missing SDU percentage threshold) indicated by a condition configuration associated with the second NC state, if a survival timer associated the second NC state is not running, the WTRU may (i) set an initial value of the survival timer to a missing SDU detection duration indicated by the condition configuration, (ii) start the survival timer and (iii) reset a missing SDU event counter associated with the second NC state. If the survival timer associated the second NC state is running, the WTRU may increase the missing SDU event counter by one.

Based on (e.g., in response to) the missing SDU event counter reaching the missing SDU accumulation threshold indicated by the condition configuration associated with the second NC state, the WTRU may stop the survival timer and determine that the condition of switching to the second NC state may be satisfied.

Based on (e.g., in response to) the survival timer expiring, the WTRU may reset the missing SDU event counter.

### Example of Condition Determination Based on PDU Forwarding Method

In an example, the WTRU may perform the determination (e.g., of whether a condition of transition to the second NC state may have been satisfied) based on PDU forwarding method.

In one example, the WTRU may be indicated by a gNB to apply a (e.g., specific) PDU submission method via a PDU submission indication e.g., dynamically. For example, after the WTRU may receive a PDU submission indication from the gNB, the PDU submission indication indicating to apply a (e.g., specific) PDU submission method, the WTRU may submit the PDU to lower layer based on the (e.g., specific) PDU submission method. A (e.g., each) PDU submission method may be associated with a NC configuration indicated by the condition configuration. The WTRU may determine which NC configuration to be applied for a NC process based on which PDU submission method is indicated to apply.

In one example, each of PDU submission method may be associated with a NC state (indicated by the condition configuration). The WTRU may determine which NC state to transition for a NC process based on which PDU submission method may be indicated to apply.

In one example, the WTRU may be indicated by a gNB to apply a specific (set of) RLC entity for a NC process via a RLC entity indication e.g., dynamically. For example, after the WTRU may receive a RLC entity indication from the gNB, the RLC entity indication indicating to apply a specific (set of) RLC entity for PDU submission for a NC process the WTRU may submit the PDU to the (set of) RLC entity indicated by the RLC entity indication. One (e.g., each (set)) of the RLC entities may be associated with a NC configuration indicated by the condition configuration. The WTRU may determine which NC configuration may be to be applied for a NC process based on which (set of) RLC entity may be indicated to apply for the PDU submission. In another example, the WTRU may determine which NC state to transition for a NC process based on which (set of) RLC entity may be indicated to apply for the PDU submission.

In one example, the WTRU may be indicated by a gNB to apply a specific (set of) RLC bearer for a NC process via a RLC bearer indication e.g., dynamically. For example, after the WTRU may receive a RLC bearer indication from the gNB, the RLC bearer indication indicating to apply a specific (set of) RLC bearer for PDU submission for a NC process the WTRU may submit the PDU to the (set of) RLC bearer indicated by the RLC bearer indication. One (e.g., each of (set of)) RLC bearer may be associated with a NC configuration indicated by the condition configuration. The WTRU may determine which NC configuration may be to be applied for a NC process based on which (set of) RLC bearer may be indicated to apply for the PDU submission. In another example, the WTRU may determine which NC state to transition for a NC process based on which (set of) RLC bearer may be indicated to apply for the PDU submission.

In one example, one (e.g., each of) the configured NC configurations may be associated with a RLC entity activation number threshold. A RLC entity activation number threshold may indicate a number of activated RLC entity(ies) associated with a PDCP entity. The WTRU may be indicated by a gNB to activate a specific (set of) RLC entity for a NC process via a RLC entity indication e.g., dynamically. For example, after the WTRU may receive a RLC entity indication from the gNB, RLC entity indication indicating to activate a specific (set of) RLC entity for PDU submission for a NC process, the WTRU may submit the PDU to the (set of) RLC entity indicated by the RLC entity indication. One (e.g., each of) the configured NC configurations may be associated with a RLC entity association number threshold. The WTRU may determine which NC configuration may be to be applied for a NC process based on the number of RLC entity that may be indicated to be activated. In a first example, the RLC entity activation number threshold may indicate a (e.g., maximum) number of activated RLC entities. The WTRU may determine to apply a NC configuration if the number of activated RLC entity is equal to or greater than the RLC entity activation number threshold. In a second example, the RLC entity activation number threshold may indicate a range of number of activated RLC entities. The WTRU may determine to apply a NC configuration if the number of activated RLC entity is within the range indicated by the RLC entity activation number threshold.

In another example, the WTRU may determine which NC state to transition for a NC process based on the number of RLC entity that may be indicated to be activated. In a first example, the RLC entity activation number threshold may indicate a (e.g., maximum) number of activated RLC entities. The WTRU may determine to transition to a NC state if the number of activated RLC entity is equal to or greater than the RLC entity activation number threshold. In a second example, the RLC entity activation number threshold may indicate a range of number of activated RLC entities. The WTRU may determine to transition to a NC state if the number of activated RLC entity is within the range indicated by the RLC entity activation number threshold.

### Example of Condition Determination Based on Scheduling

In an example, the WTRU may perform the determination (e.g., of whether a condition of transition to the second NC state may have been satisfied) based on scheduling.

In one example, the WTRU may receive uplink grant (e.g., information) for the PDU transmission. The uplink grant (e.g., information) may be received via one or more DCI transmitted on PDCCH from a gNB. One (e.g., each of the one o more) DCI may have different types of formats. For example, the WTRU may receive one or more DCIs with different formats indicating uplink resources on PUSCH. In one example, uplink resource may (e.g., only) be used for the PDU transmission (generated by the NC process).

A (e.g., each (set of)) format(s) of the DCI may be associated with a NC configuration indicated by the condition configuration. The WTRU may determine which NC configuration to be applied for a NC process based on which format(s) of DCI may be received.

A (e.g., each (set of)) format(s) of the DCI may be associated with a NC state (indicated by the condition configuration). The WTRU may determine which NC state to transition for a NC process based on which format(s) of DCI may be received.

In another example, any of a NC configuration switching and a NC state switching indicator may be carried by a field of a DCI. The field may explicitly indicate the WTRU to switch to a (e.g., particular) NC configuration or a (e.g., particular) NC state. Or the field may explicitly indicate the WTRU to switch NC configuration or NC state.

In another example, via a condition configuration, the WTRU may be indicated an association between a NC configuration and a type of RNTI. For example, the WTRU may receive one or more DCIs with CRC bits scrambled by different types of RNTI. The WTRU may determine which NC configuration to be applied for a NC process based on which type of RNTI may be applied to be scrambled with the CRC bits of the received DCI.

In another example, (via a condition configuration) the WTRU may be indicated an association between a NC state and a type of RNTI. For example, the WTRU may receive one or more DCIs with CRC bits scrambled by different types of RNTI. The WTRU may determine which NC state to transition for a NC process based on which type of RNTI may be applied to be scrambled with the CRC bits of the received DCI.

In another example, a (e.g., specific) NC configuration may be associated with a PDCP duplication configured to a PDCP entity. The WTRU may determine to apply the (e.g., specific) NC configuration for a NC process configured for the PDCP entity based on the activation/deactivation status of the PDCP duplication function. For example, the WTRU may apply the (e.g., specific) NC configuration if the PDCP duplication is activated.

In another example, a (e.g., specific) NC state may be associated with a PDCP duplication configured to a PDCP entity. The WTRU may determine to transition to the (e.g., specific) NC configuration for a NC process configured for the PDCP entity based on the activation/deactivation status of the PDCP duplication function. For example, the WTRU may transition to the specific NC state if the PDCP duplication is activated.

In another example, a (e.g., specific) NC configuration of a (e.g., specific) NC state may be associated with any of (i) a (e.g., specific) size of uplink grant or downlink scheduling (e.g., in case of a UL grant with size larger (smaller) than the (e.g., specific) size is received, the WTRU may switch to the (e.g., specific) NC configuration/NC state), (ii) a (e.g., specific) configured bandwidth part (BWP) (e.g., in a case where the WTRU is switched to the (e.g., specific) BWP, the WTRU may switch to the (e.g., specific) NC configuration/NC state), (iii) a BWP configured with a (e.g., specific) subcarrier spacing (SCS) (e.g., in a case where the WTRU is switched to a BWP with the (e.g., specific) SCS configuration, the WTRU may switch to the (e.g., specific) NC configuration/NC state, (iv) a serving cell (which may be configured to be operated in licensed/unlicensed spectrum), and (v) a (e.g., specific) HARQ process ID. For example, in a case where the serving cell is activated/deactivated, the WTRU may switch to the (e.g., specific) NC configuration/NC state. For example, in a case where an UL grant of a DL scheduling is received on the serving cell, the WTRU may switch to the (e.g., specific) NC configuration/NC state. For example, in a case where an UL grant indicating a PUSCH transmission on the serving cell is received, the WTRU may switch to the specific NC configuration/NC state. For example, in a case where a DL scheduling indicating a physical downlink shared channel (PDSCH) reception on the serving cell is received, the WTRU may switch to the (e.g., specific) NC configuration/NC state. For example, in a case where a UL grant indicating a PUSCH transmission by using a HARQ process with the specific HARQ process ID is received, the WTRU may switch to the (e.g., specific) NC configuration/NC state. For example, in a case where a DL scheduling indicating a PDSCH reception by using a HARQ process with the specific HARQ process ID is received, the WTRU may switch to the (e.g., specific) NC configuration/NC state.

### Example of Condition Determination Based on Measurement.

In an example, the WTRU may perform the determination (e.g., of whether a condition of transition to the second NC state may have been satisfied) based on measurement.

For example, the evaluation may be based on whether a reference signal measurement may be lower than a threshold.

In one example, the WTRU may be indicated one or more measurement configurations by the gNB e.g., through RRC. A (e.g., each) measurement configuration may indicate one or more reference signals (e.g., any of synchronization signal (SS)/physical broadcast channel (PBCH) block(s) and channel state information reference signal (CSI-RS) resources) to be measured, and the measurement information to be reported to the gNB (any of RSRP, reference signal receive quality (RSRQ), signal to interference noise ratio (SINR), interference measurement quantities, etc.). The measurement configuration may further indicate one or more reporting configurations which may indicate any of a WTRU measurement trigger event/reporting criterion and a reporting format e.g., (per cell, or per reference signal or per beam). A (e.g., specific) NC configuration may be associated with a RSRP threshold and/or received signal strength indicator (RSSI) threshold. The WTRU may determine whether to apply the (e.g., specific) NC configuration based on the measurement result. For example, the WTRU may apply the (e.g., specific) NC configuration if the measurement result is equal to or lower than the threshold.

In one example, the WTRU may determine whether to transition to the (e.g., specific) NC configuration based on the measurement result. For example, the WTRU may transition to the (e.g., specific) NC state if the measurement result is equal to or lower than the threshold.

In another example, the radio measurements and triggers may be configured in the WTRU to assist evaluating the cell geometry or the signal geometry as perceived by the WTRU and to determine whether the WTRU is at cell edge in support of a determination to activate or deactivate NC protocol. For example, the WTRU may be configured with a currently specified measurement event as reporting criterion. For example, NC related specific events which may be referred to as A3, A4, A5, A6 or I1 (as defined in 3GPP TS 38.331 V18.1.0, “NR; Radio Resource Control (RRC); Protocol specification”) as a mean to evaluate whether the WTRU is at the cell edge, may be configured in the WTRU. Such events and associated measurements may be reported in support of measurement reports to the base station, which may decide to activate or deactivate NC protocol. In another example, the WTRU may use such measurements and may trigger to activate or deactivate NC protocol based on the measurements.

### Example of Condition Determination Based on NC Configuration Switching Indicator

In an example, the WTRU may perform the determination (e.g., of whether a condition of transition to the second NC state may have been satisfied) based on NC configuration switching indicator.

For example, the evaluation may be based on whether a NC configuration switching indicator may be received, the NC configuration switching indicator indicating the WTRU to switch to the second NC configuration for a NC process. In one example, the NC configuration switching indicator may indicate the WTRU to transition to a second NC state for a NC process. The NC configuration switching indicator may be carried by any of a downlink MAC CE, a control PDCP PDU, a header of a PDCP PDU, and a DCI with CRC bits scrambled by a (e.g., specific) type of RNTI (e.g., CS-RNTI), wherein the DCI may include an NDI with (e.g., specific) value, and wherein the DCI may be associated with a HARQ process which HARQ buffer stored data of the DRB, the DRB being configured with survivalTimeStateSupport.

In one example, the received downlink MAC CE may include a radio bearer indicator. The WTRU may determine the association between the downlink MAC CE and the NC process based on the radio bearer indicator. In another example, the received downlink MAC CE may include a NC process indicator. The WTRU may determine the association between the downlink MAC CE and the NC process based on the NC process indicator.

If the NC configuration switching condition is not satisfied, the WTRU may keep applying the first NC configuration.

If the NC state transitioning condition is not satisfied, the WTRU may keep applying the first NC configuration.

### Other Examples of Condition Determination

In one example, the WTRU may determine to apply a (e.g., specific) NC configuration based on whether a (e.g., specific) timer may be running or not. For example, the WTRU may determine to apply a (e.g., specific) NC configuration if a beam failure recovery timer may be running.

In one example, the WTRU may determine to transition to a (e.g., specific) NC state based on whether a (e.g., specific) timer may be running or not. For example, the WTRU may determine to transition to a (e.g., specific) NC state if a beam failure recovery timer may be running.

In another example, the WTRU may determine to apply a (e.g., specific) NC configuration based on a NC state. In one example, there may be multiple NC states for a NC process. A (e.g., each) NC state may be associated with a NC configuration. The WTRU may transition from a NC state to another NC state based on any of a gNB's indication and a WTRU's determination. The determination of state transition may be performed by the WTRU based on one or more of condition configuration as described in embodiments described herein. For example, the WTRU may determine to apply a NC configuration if the WTRU transitions to a NC state associated with the NC configuration.

In another example, the WTRU may determine to apply a (e.g., specific) NC configuration to a NC process configured to a PDCP entity based on whether a (e.g., specific) logical channel prioritization (LCP) restriction may be applied to the logical channel associated with the PDCP entity. For example, if the WTRU is applying an LCP restriction to the logical channel, the WTRU may apply the (e.g., specific) NC configuration.

In another example, the WTRU may determine to apply a (e.g., specific) NC configuration to a NC process configured to a PDCP entity based on whether a (e.g., specific) configured grant configuration may be activated. For example, if the configured grant configuration is activated, the WTRU may apply the (e.g., specific) NC configuration.

As shown at 64, based on the outcome of the switching NC configuration evaluation performed as shown at 63, if the NC configuration is determined to be switched, the WTRU may operate as shown at 65, otherwise, the WTRU may operate as shown at 63.

As shown at 65, after determining to switch to the second NC configuration for the NC process, the WTRU may switch to the second NC configuration for the NC process.

In state-based NC configuration switching, after determining to transition to the second NC state for the NC process, the WTRU may transition to the second NC state, and may apply the second NC configuration associated with the second NC state for the NC process.

In one example, while applying the second NC configuration, the WTRU may apply a coefficient matrix indicated by the coefficient matrix configuration to generate PDU(s), and may submit the generated PDU(s) to a second group of RLC entity(ies) e.g., indicated by the NC configuration.

In an example, the NC process may start to apply the second NC configuration when processing a PDU with a NC PDU set SN.

As shown at 66, after switching from a first NC configuration to a second NC configuration for a NC process, the WTRU may transmit a NC configuration switching confirmation to the gNB. The NC configuration switching confirmation may include at least an indicator indicating the second NC configuration applied by the WTRU.

In one example, after switching from a first NC state to a second NC state for a NC process, the WTRU may transmit a NC configuration switching confirmation to the gNB. The NC configuration switching confirmation may include at least an indicator indicating the second NC configuration applied by the WTRU.

In one example, the WTRU may transmit a NC configuration switching confirmation including a NC configuration index and/or the NC PDU set SN to the gNB. For example, the NC configuration index may be associated with the second NC configuration. For example, the NC configuration index may be associated with the second NC state. The NC configuration switching confirmation may carried by any of a DCI field, an uplink control information (UCI), and a MAC CE.

### Second Example of Network Coding Control

A second example of NC control is described herein.

### Activation/Deactivation of NC Protocol

If one or more DRBs are configured with NC protocol, the network may activate and deactivate the NC protocol for all or a subset of any of associated RLC entities and associated network coding methods for the configured DRB(s).

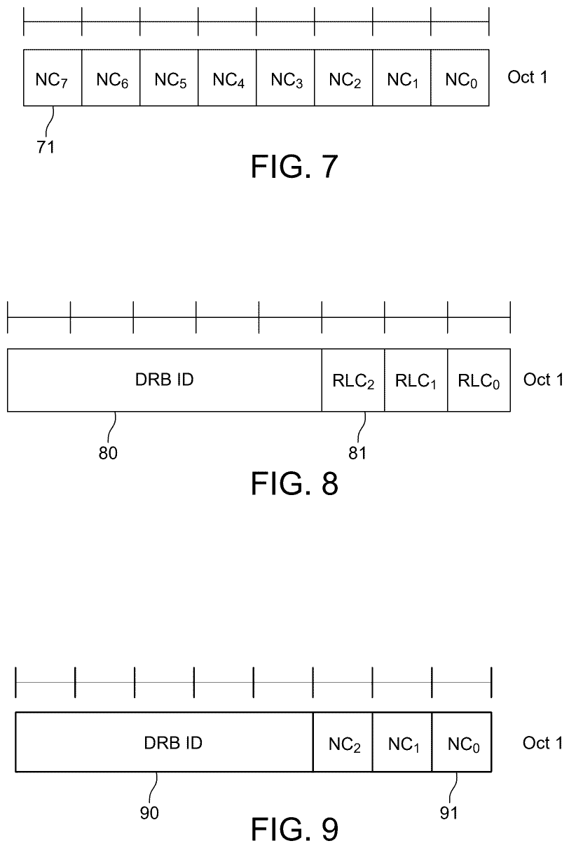

At the WTRU, the NC protocol for the configured DRB(s) may be activated and deactivated based on any of (i) receiving the NC protocol activation/deactivation MAC CE as shown at FIG. 7, (ii) receiving the NC protocol RLC activation/deactivation MAC CE as shown at FIG. 8, (iii) receiving the NC protocol method activation/deactivation MAC CE as shown at FIG. 9, and (iv) receiving a NC protocol activation/deactivation indicator which may be carried by any of a DCI field, a MAC CE and a RRC signaling message.

At the WTRU, the NC protocol for all or a subset of any of associated RLC entities and network coding methods for the configured DRB(s) may be activated and/or deactivated by any of (i) receiving network coding RLC activation/deactivation MAC CE as shown at FIG. 8, (ii) receiving the NC protocol method activation/deactivation MAC CE as shown at FIG. 9, and (iii) an indication by RRC.

At the WTRU, the NC protocol for (e.g., all) associated RLC entities or network coding methods for the configured DRB(s) may be activated based on receiving an uplink grant addressed to CS-RNTI with NDI=X for a logical channel associated with the DRB configured with survivalTimeStateSupport, wherein X may take the value 1, 2 or any other numerical value.

MAC Behavior for Activation/Deactivation of NC Protocol using MAC CE

For a (e.g., each) DRB configured with NC protocol, if a network coding activation/deactivation MAC CE is received (e.g., indicating) activating the NC protocol of the DRB, the MAC entity may indicate the activation of NC protocol of the DRB to the upper layers.

For a (e.g., each) DRB configured with NC protocol, if a network coding RLC activation/deactivation MAC CE or network coding method activation/deactivation MAC CE is received (e.g., indicating) deactivating the NC protocol of the DRB, the MAC entity may indicate the deactivation of NC protocol of the DRB to the upper layers.

For a (e.g., each DRB) configured with NC protocol, if a network coding RLC activation/deactivation MAC CE or network coding method activation/deactivation MAC CE is received (e.g., indicating) activating the NC protocol for associated RLC entities or network coding methods of a DRB configured with NC protocol, the MAC entity may indicate the activation of NC protocol for the indicated secondary RLC entity(ies) or network coding method of the DRB to upper layers.

For a (e.g., each DRB) configured with NC protocol, if a network coding RLC activation/deactivation MAC CE or network coding method MAC CE is received (e.g., indicating) deactivating the NC protocol for associated RLC entities of a DRB configured with NC protocol, the MAC entity may indicate the deactivation of NC protocol for the indicated secondary RLC entity(ies) of the DRB to upper layers.

For a (e.g., each DRB) configured with NC protocol, if activation of a NC protocol for (e.g., all) configured RLC entities or network coding methods is triggered for the DRB as described herein, for example, if an uplink grant addressed to CS-RNTI with NDI=X for a logical channel associated with the DRB configured with survivalTimeStateSupport is received, the MAC entity may indicate the activation of NC protocol for (e.g., all) configured RLC entities or (e.g., all) configured network coding methods of the DRB to the upper layers.

Network coding Activation/Deactivation MAC CE

A network coding activation/deactivation MAC CE of one byte may is identified by a MAC sub-header with a (e.g., new) logical channel identifier (LCID) specific to (e.g., indicating) the network coding activation/deactivation MAC CE. The LCID may be one byte long. It may have a fixed size and may comprise of a single byte containing eight NC-fields.

FIG. 7 is a diagram illustrating an example network coding activation/deactivation MAC CE for a MAC entity. The field referred to as NCi 71 (with i being an integer ranging from 0 to 7) may indicate the activation/deactivation status of the NC protocol of DRB i where i may be the ascending order of the DRB ID among the DRBs configured with NC protocol and with RLC entity(ies) associated with this MAC entity. The NCi field 71 may be set to 1 to indicate that the NC protocol of DRB i may be activated. The NCi field 71 may be set to 0 to indicate that the NC protocol of DRB i may be deactivated.

The network coding activation/deactivation MAC CE may not used if a DRB is configured with more than one RLC entities, e.g., with more ThanOneRLC-DRB.

FIG. 8 is a diagram illustrating an example network coding RLC activation/deactivation MAC CE. The network coding RLC activation/deactivation MAC CE may be identified by a MAC sub-header with an extended LCID (eLCID) specific to (e.g., indicating) the network coding RLC activation/deactivation MAC CE. The eLCID may be one byte long. It may have a fixed size and may comprise a single byte as shown at FIG. 8.

A first field referred to as DRB ID 80 may indicate the identity of the DRB for which the MAC CE may apply. The length of the field may be of five bits.

A second field referred to as RLCi 81 may indicate the activation/deactivation status of NC protocol for the RLC entity i where i may be ascending order (e.g., integer) of logical channel ID of secondary RLC entities in the order of master cell group (MCG) and secondary cell group (SCG), for the DRB. The RLCi field 81 may be set to 1 to indicate that the NC protocol for the RLC entity i may be activated. The RLCi field 81 may be set to 0 to indicate that the NC protocol for the RLC entity i may be deactivated.

FIG. 9 is a diagram illustrating an example network coding method activation/deactivation MAC CE. A network coding method activation/deactivation MAC CE may be identified by a MAC sub-header with eLCID (extended LCID) specific to (e.g., indicating) the network coding method activation/deactivation MAC CE. The eLCID may be one byte long. It may have a fixed size and may comprise of a single byte as shown at FIG. 9.

A first field referred to as DRB ID 90 may indicate the identity of the DRB for which the MAC CE may apply. The length of the field may be, for example, of five bits.

A second field referred to as NCi 91 may indicate the activation/deactivation status of NC protocol for the network coding method i where i may be ascending order (e.g., integer) of secondary network coding methods in the order of MCG and SCG, for the DRB. The NCi field 91 may be set to 1 to indicate that the NC protocol for the network coding method i may be activated. The NCi field 91 may be set to 0 to indicate that the NC protocol for the network coding method i may be deactivated.

### PDCP Behavior When Activation/Deactivation of NC Protocol MAC CE may be Received

For signaling radio bearers (SRBs), the transmitting PDCP entity (e.g., configured with NC protocol) may activate the NC protocol.

For data radio bearers (DRBs), if the activation of NC protocol is indicated for the DRB, the transmitting PDCP entity may activate the NC protocol for the DRB.

For DRBs, if the activation of NC protocol is indicated for at least one associated RLC entities, the transmitting PDCP entity may activate the NC protocol for the indicated associated RLC entities and may activate the NC protocol for the DRB.

For DRBs, if the deactivation of NC protocol is indicated for the DRB, the transmitting PDCP entity may deactivate the NC protocol for the DRB.

For DRBs, if the deactivation of NC protocol is indicated for at least one of the associated RLC entities, the transmitting PDCP entity may deactivate the NC protocol for the indicated at least one of the associated RLC entities. In an example, if (e.g., all) associated RLC entities other than the primary RLC entity are deactivated for NC protocol, the transmitting PDCP entity may deactivate the NC protocol for the DRB. In another example, if (e.g., all) associated RLC entities are deactivated for NC protocol, the transmitting PDCP entity may deactivate the NC protocol for the DRB.

For DRBs, if the activation of NC protocol is indicated for at least one associated network coding method, the transmitting PDCP entity may activate the NC protocol for the indicated a least one associated network coding method and may activate the NC protocol for the DRB.

For DRBs, if the deactivation of NC protocol is indicated for at least one associated RLC network coding method, the transmitting PDCP entity may deactivate the NC protocol for the indicated associated RLC entities. If (e.g., all) associated network coding method are deactivated for NC protocol, the transmitting PDCP entity may deactivate the NC protocol for the DRB.

### PDU Discard

If a successful delivery of a Data SDU or Data SDU set is confirmed by a peer PDCP entity, the transmitting PDCP (e.g., configured with NC protocol) may indicate to (e.g., all) associated RLC entities to discard (e.g., all) the data PDUs associated with the SDU or the SDU set.

If a deactivation of NC protocol is indicated for the DRB, the transmitting PDCP (e.g., configured with NC protocol) may indicate to the RLC entities other than the primary RLC entity to discard (e.g., all) data PDUs.

If a deactivation of NC protocol is indicated for at least one of the associated RLC entities, the transmitting PDCP (e.g., configured with NC protocol) may indicate to the RLC entities deactivated for NC protocol to discard (e.g., all) data PDUs.

### Independent NC Configuration

In embodiments described herein a NC configuration described herein may refer to a NC method.

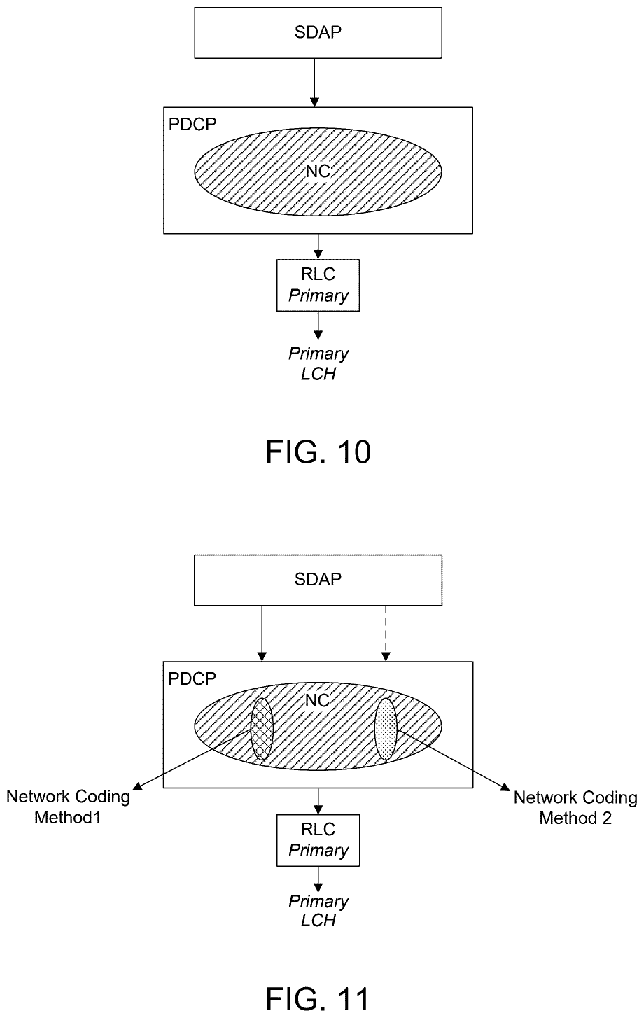

FIG. 10 is a diagram illustrating an example NC protocol with (e.g., only) one coding method activated. When network coding is configured for a radio bearer by RRC, at least one network coding method may be added to the radio bearer to perform network coding of the SDUs as shown at FIG. 10.

FIG. 11 is a diagram illustrating an example NC protocol with at least one secondary coding method activated. When network coding is configured with a network coding method diversity for a radio bearer by RRC, at least one secondary coding method may be added to the radio bearer to handle the SDUs as shown at FIG. 11.

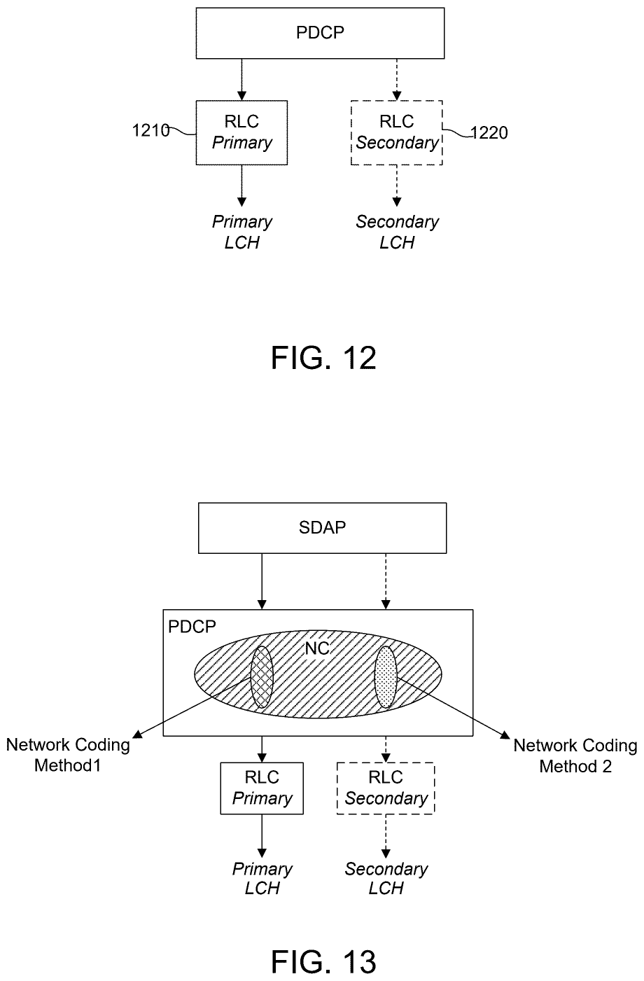

FIG. 12 is a diagram illustrating an example NC protocol with at least one secondary RLC entity activated. In an example, network coding may be configured for a radio bearer e.g., by RRC, with or without transmission path diversity. When network coding is configured with RLC path diversity for a radio bearer by RRC, at least one secondary RLC entity may be added to the radio bearer to handle the PDUs as shown at FIG. 12. The logical channel corresponding to the primary RLC entity 1210 may be referred to as the primary logical channel, and the logical channel corresponding to the secondary RLC entity(ies) 1220 may be referred to as the secondary logical channel(s). In one example, (e.g., all) the RLC entities may have the same RLC mode. In another example, the RLC entities may have different RLC modes.

FIG. 13 is a diagram illustrating an example NC protocol. Network coding at PDCP may include transforming one or more SDUs into several PDUs using a network coding method configured by the PDU routing configuration and routing PDUs to the activated RLC entities for the radio bearer as shown at FIG. 13. With multiple independent network coding methods and/or transmission paths, network coding may increase reliability and may reduce latency which may be useful for URLLC services eMBB services with ultra-reliable and low latency requirements.

When configuring network coding for a DRB, RRC may (e.g., also) set (e.g., indicate) the state of NC protocol (either activated or deactivated) at the time of (re-)configuration. In one example, after the configuration, the NC protocol state may be dynamically controlled by means of a MAC control element and in DC, the WTRU may apply the MAC CE commands regardless (independently) of their origin (MCG or SCG).

In an example, when network coding is configured for an SRB, the state may (e.g., always) be active and may not be dynamically controlled. In another example, the network coding state may be dynamically controlled for an SRB. When configuring network coding for a DRB with at least one secondary RLC entity, RRC may set (e.g., indicate) the state of (e.g., each of) them (e.g., activated/deactivated). Subsequently, a MAC CE may be used to (e.g., dynamically) control (e.g., indicate) whether (e.g., each of) the configured secondary RLC entities for a DRB may be activated or deactivated, e.g., which of the RLC entities may be used for PDU transmission. Primary RLC entity may not be deactivated. If network coding is deactivated for a DRB, (e.g., all) secondary RLC entities associated to this DRB may be deactivated. If a secondary RLC entity is deactivated, it may not be re-established, the HARQ buffers may not be flushed, and the transmitting PDCP entity may indicate to the secondary RLC entity to discard (e.g., all) PDUs.

When configuring network coding for a DRB with at least one secondary coding method, RRC may set (e.g., indicate) the state of (e.g., each of) them (e.g., activated/deactivated). Subsequently, a MAC CE may not be used to dynamically control whether (e.g., each of) the configured secondary coding method for a DRB may be activated or deactivated, e.g., which of the coding methods may be used for network coding. Network coding may be deactivated if primary network coding method is deactivated. When network coding is deactivated for a DRB, (e.g., all) secondary network coding methods associated with this DRB are deactivated.

When activating network coding for a DRB, NG-RAN may ensure that at least one serving cell may activated for a (e.g., each) logical channel associated with an activated RLC entity of the DRB. When the deactivation of secondary cells (SCells) leaves no serving cells activated for a logical channel of the DRB, NG-RAN may ensure that network coding may (e.g., also) be deactivated for the RLC entity associated with the logical channel.

When network coding is activated, the PDUs mapped to (e.g., associated with) different RLC entities may not be transmitted on the same carrier. The logical channels of a radio bearer configured with network coding may belong to the same MAC entity (referred to as CA network coding) or to different entities (referred to as DC network coding). CA network coding may (e.g., also) be configured in any of the MAC entities (e.g., together) with DC network coding when network coding over more than two RLC entities is configured for the radio bearer. In CA network coding, logical channel mapping restrictions may be used in a MAC entity to ensure that the different logical channels of a radio bearer in the MAC entity may not be sent on the same carrier. When CA network coding is configured for an SRB, one of the logical channels associated with the SRB may be mapped to (e.g., associated with) a special cell (SpCell).

In an example, CA network coding may be deactivated for a DRB in a MAC entity (e.g., none or (e.g., only) one of the RLC entities of the DRB in the MAC entity may remain activated). The logical channel mapping restrictions of the logical channels of the DRB may be lifted for (e.g., as long as) CA network coding may remain deactivated for the DRB in the MAC entity.

In an example, an RLC entity may acknowledge the transmission of a PDCP PDU. The PDCP entity may indicate to the other RLC entity(ies) to discard it. In case of CA network coding, when an RLC entity restricted to only SCell(s) reaches the maximum number of retransmissions for a PDCP PDU, the WTRU may inform the gNB and may not trigger radio link failure (RLF).

### WTRU Assistance Information to the Network

A transmitting WTRU may report (e.g., transmit) to the base station, assistance information for NC protocol.

Assistance information for NC protocol may include any of (i) radio measurements and triggers (e.g., RSRP, RSRQ, SINR, channel busy ratio (CBR), channel quality indicator (CQI)) based measurement reports, (ii) uplink transmit power being at maximum, or some form of power reduction may have been applied (e.g., power management maximum power reduction (P-MPR)), (iii) other measurements and triggers (e.g., position, speed, orientation, etc.), (iv) conditions related to data available for transmission for any of a radio bearer, logical channel, logical channel group, PDU session identity (PSI) and/or PDU set QoS parameters, (v) device capability or delta capability, (vi) computation resource (e.g., CPU, GPU) and/or memory resources for e.g. available computation resource (e.g. CPU, GPU) and/or memory resources, or capability or delta capability with respect to computation resource (e.g. CPU, GPU) and/or memory resources, (vii) battery level e.g., available battery level, and (viii) characteristics of SDUs or PDUs in the WTRU buffer.

### Activation/Deactivation of NC Configuration

In one example, a WTRU may be configured by a gNB, with multiple NC configurations. One (e.g., each) of the multiple NC configurations may be indicated by the gNB to be activated or deactivated individually. For example, (e.g., only) the activated NC configuration may be applied by the WTRU for a NC process.

In another example, a WTRU may be configured by a gNB, with multiple NC configurations. One (e.g., each) of the multiple NC configurations may be indicated by the gNB to be associated with a NC state. One (e.g., each) of the NC configuration may be activated or deactivated individually. For example, (e.g., only) the activated NC configuration may be applied by the WTRU for the NC state.

In other examples, a WTRU may be configured by a gNB, with multiple NC configurations. One (e.g., each) of the multiple NC configurations may be indicated by the gNB to be associated with a NC process. One (e.g., each) of the NC configuration may be activated or deactivated individually. For example, (e.g., only) the activated NC configuration may be applied by the WTRU for the NC process.

The WTRU may be indicated by the gNB to activate or deactivate by a NC configuration activation/deactivation command. The NC configuration activation/deactivation command may be (e.g., included in) any of a DCI, a MAC CE and a RRC information element (IE). The NC configuration activation/deactivation command may include (e.g., indicate) one or more of a NC process ID, a bearer ID, a NC configuration index, and an activation/deactivation indicator.

For example, the NC configuration activation/deactivation command may include a NC process ID and an activation/deactivation indicator. The activation/deactivation indicator may indicate the WTRU to activate or deactivate one or more NC configurations associated with a NC process indicated by the NC process ID.

In another example, the NC configuration activation/deactivation command may include a bearer ID and an activation/deactivation indicator. The activation/deactivation indicator may indicate the WTRU to activate or deactivate one or more NC configurations associated with a bearer indicated by the bearer ID.

In other examples, the NC configuration activation/deactivation command may include a NC configuration index and an activation/deactivation indicator. The activation/deactivation indicator may indicate the WTRU to activate or deactivate one or more NC configurations associated with the NC configuration index.

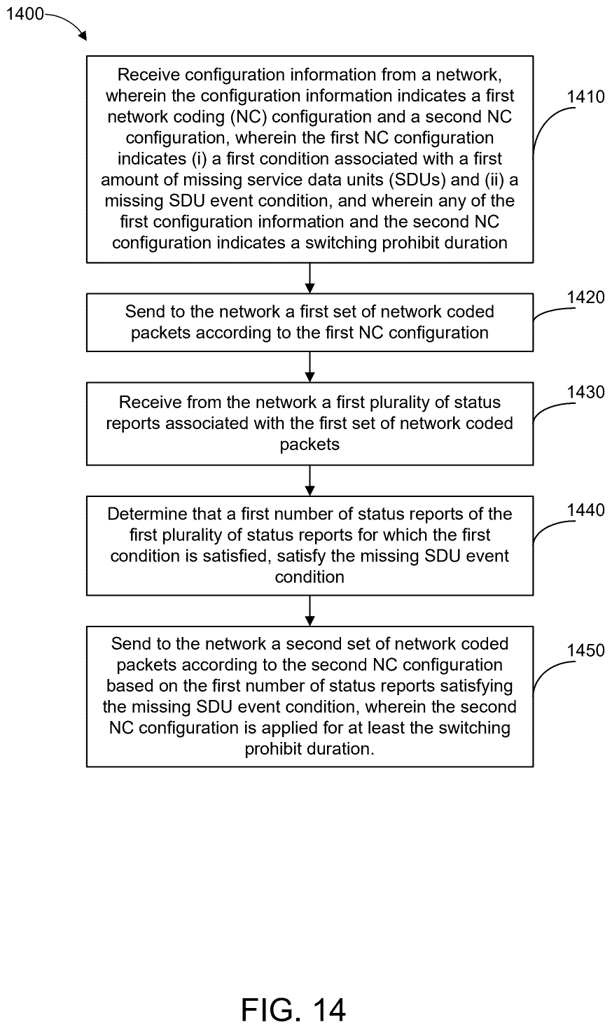

FIG. 14 is a diagram illustrating an example method 1400 for controlling network coding, implemented in a WTRU. The WTRU may include circuitry including any of a transmitter, a receiver, a processor, and a memory. The circuitry may be configured to carry out the method 1400. As shown at 1410, the method 1400 may include receiving configuration information from a network. In various embodiments, the configuration information may indicate a first NC configuration and a second NC configuration. In various embodiments the first NC configuration and the second NC configuration may be received in a single or in two different messages (e.g., transmissions). In various embodiments, the first NC configuration may indicate (i) a first condition associated with a first amount of missing service data units (SDUs) and (ii) a missing SDU event condition. In various embodiments, any of the first NC configuration and the second NC configuration may indicate a switching prohibit duration. As shown at 1420, the method 1400 may further include sending to the network a first set of network coded packets according to the first NC configuration. As shown at 1430, the method 1400 may further include receiving from the network a first plurality of status reports associated with the first set of network coded packets. As shown at 1440, the method 1400 may further include determining that a first number of status reports of the first plurality of status reports for which the first condition is satisfied, may satisfy the missing SDU event condition. As shown at 1450, the method 1400 may further include sending to the network a second set of network coded packets according to the second NC configuration based on the first number of status reports satisfying the missing SDU event condition. In various embodiments, the second NC configuration may be applied for at least the switching prohibit duration.

In various embodiments, the first condition may comprise a first threshold. In various embodiments, the first condition may be satisfied for a status report of the first plurality of status reports if the status report indicates a first number of missing SDUs equal to or greater than the first threshold.

In various embodiments, the missing SDU event condition may comprise a missing SDU accumulation threshold. In various embodiments, the first number of status reports of the first plurality of status reports for which the first condition is satisfied, may satisfy the missing SDU event condition if the first number of status reports of the first plurality of status reports for which the first condition is satisfied is equal to or greater than the missing SDU accumulation threshold.

In various embodiments, the first NC configuration may indicate a duration for detecting missing SDUs.

In various embodiments, the second NC configuration may indicate a second condition associated with a second amount of missing SDUs.

In various embodiments, the method may comprise receiving from the network, at least one status report associated with at least a part of the second set of network coded packets and sending to the network a third set of network coded packets according to the first NC configuration based on the at least one status report associated with the at least a part of the second set of network coded packets failing to satisfy the second condition.

In various embodiments, the second condition may comprise a second threshold. In various embodiments, the at least one status report associated with the at least a part of the second set of network coded packets may fail to satisfy the second condition if the at least one status report associated with the at least a part of the second set of network coded packets indicates a second number of missing SDUs smaller than the second threshold.

In various embodiments, the method may comprise receiving from the network, at least one status report associated with at least a part of the second set of network coded packets and remaining in the second NC configuration for sending to the network a third set of network coded packets based on the at least one status report associated with the at least a part of the second set of network coded packets satisfying the second condition.

In various embodiments, the method may comprise applying the second NC configuration after the switching prohibit duration may have elapsed on condition that no status report associated with the second set of network coded packets is received from the network.

In various embodiments, the first NC configuration may indicate a first set of coding coefficients.

In various embodiments, the second NC configuration may indicate a second set of coding coefficients.

In various embodiments, the first NC configuration may indicate the switching prohibit duration.

In various embodiments, the second NC configuration may indicate the switching prohibit duration.

In various embodiments, the method may comprise sending information to the network after the determination that the first number of status reports for which the first condition is satisfied, may satisfy the missing SDU event condition. In various embodiments, the information may indicate the second NC configuration.

The content of each of the following references is incorporated by reference herein in its entirety:
3GPP Technical Specification TS 38.323 V18.0.0 “Packet Data Convergence Protocol (PDCP) specification”.
3GPP TS 38.331 V18.1.0 “NR; Radio Resource Control (RRC); Protocol specification”.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A wireless transmit/receive unit (WTRU) comprising circuitry, including any of a transmitter, a receiver, a processor, and a memory, wherein the circuitry is configured to:
receive configuration information from a network, wherein the configuration information indicates a first network coding (NC) configuration and a second NC configuration, wherein the first NC configuration indicates (i) a first condition associated with a first amount of missing service data units (SDUs) and (ii) a missing SDU event condition, and wherein any of the first NC configuration and the second NC configuration indicate a switching prohibit duration;
send to the network a first set of network coded packets according to the first NC configuration;
receive from the network a first plurality of status reports associated with the first set of network coded packets;
determine that a first number of status reports of the first plurality of status reports for which the first condition is satisfied, satisfy the missing SDU event condition; and
send to the network a second set of network coded packets according to the second NC configuration based on the first number of status reports satisfying the missing SDU event condition, wherein the second NC configuration is applied for at least the switching prohibit duration.

2. The WTRU of claim 1, wherein the first condition comprises a first threshold, and wherein the first condition is satisfied for a status report of the first plurality of status reports if the status report indicates a first number of missing SDUs equal to or greater than the first threshold.

3. The WTRU of claim 1, wherein the missing SDU event condition comprises a missing SDU accumulation threshold and wherein the first number of status reports of the first plurality of status reports for which the first condition is satisfied, satisfy the missing SDU event condition if the first number of status reports of the first plurality of status reports for which the first condition is satisfied is equal to or greater than the missing SDU accumulation threshold.

4. The WTRU of claim 1, wherein the first NC configuration indicates a duration for detecting missing SDUs.

5. The WTRU of claim 1, wherein the second NC configuration indicates a second condition associated with a second amount of missing SDUs.

6. The WTRU of claim 5, wherein the circuitry is configured to receive from the network, at least one status report associated with at least a part of the second set of network coded packets and to send to the network a third set of network coded packets according to the first NC configuration based on the at least one status report associated with the at least a part of the second set of network coded packets failing to satisfy the second condition.

7. The WTRU of claim 6, wherein the second condition comprises a second threshold, and wherein the at least one status report associated with the at least a part of the second set of network coded packets fails to satisfy the second condition if the at least one status report associated with the at least a part of the second set of network coded packets indicates a second number of missing SDUs smaller than the second threshold.

8. The WTRU of claim 5, wherein the circuitry is configured to receive from the network, at least one status report associated with at least a part of the second set of network coded packets and to remain in the second NC configuration for sending to the network a third set of network coded packets based on the at least one status report associated with the at least a part of the second set of network coded packets satisfying the second condition.

9. The WTRU of claim 1, wherein the circuitry is configured to apply the second NC configuration after the switching prohibit duration has elapsed on condition that no status report associated with the second set of network coded packets is received from the network.

10. The WTRU of claim 1, wherein the first NC configuration indicates a first set of coding coefficients.

11. The WTRU of claim 1, wherein the second NC configuration indicates a second set of coding coefficients.

12. The WTRU of claim 1, wherein the first NC configuration indicates the switching prohibit duration.

13. The WTRU of claim 1, wherein the second NC configuration indicates the switching prohibit duration.

14. The WTRU of claim 1, wherein the circuitry is configured to send information to the network after the determination that the first number of status reports for which the first condition is satisfied, satisfy the missing SDU event condition, wherein the information indicates the second NC configuration.

15. A method implemented in a wireless transmit/receive unit (WTRU), the method comprising:
receiving configuration information from a network, wherein the configuration information indicates a first network coding (NC) configuration and a second NC configuration, wherein the first NC configuration indicates (i) a first condition associated with a first amount of missing service data units (SDUs) and (ii) a missing SDU event condition, and wherein any of the first NC configuration and the second NC configuration indicate a switching prohibit duration;
sending to the network a first set of network coded packets according to the first NC configuration;
receiving from the network a first plurality of status reports associated with the first set of network coded packets;
determining that a first number of status reports of the first plurality of status reports for which the first condition is satisfied, satisfy the missing SDU event condition; and
sending to the network a second set of network coded packets according to the second NC configuration based on the first number of status reports satisfying the missing SDU event condition, wherein the second NC configuration is applied for at least the switching prohibit duration.

16. The method of claim 15, wherein the first condition comprises a first threshold, and wherein the first condition is satisfied for a status report of the first plurality of status reports if the status report indicates a first number of missing SDUs equal to or greater than the first threshold.

17. The method of claim 15, wherein the missing SDU event condition comprises a missing SDU accumulation threshold and wherein the first number of status reports of the first plurality of status reports for which the first condition is satisfied, satisfy the missing SDU event condition if the first number of status reports of the first plurality of status reports for which the first condition is satisfied is equal to or greater than the missing SDU accumulation threshold.

18. The method of claim 15, wherein the first NC configuration indicates a duration for detecting missing SDUs.

19. The method of claim 15, wherein the second NC configuration indicates a second condition associated with a second amount of missing SDUs.

20. The method of claim 15, further comprising sending information to the network after the determining that the first number of status reports for which the first condition is satisfied, satisfy the missing SDU event condition, wherein the information indicates the second NC configuration.
